(19) United States
(12) Patent Application Publication
(10) Pub. No.: US 2015/0379577 A1
(43) Pub. Date: Dec. 31, 2015

(54) ADVERTISEMENT DELIVERY SYSTEM AND METHOD THEREOF, AND APPARATUS APPLIED TO THE SAME

(71) Applicant: SK Planet Co., Ltd., Seongnam-si, Gyeonggi-do (KR)

(72) Inventor: Min Ho HAN, Seoul (KR)

(21) Appl. No.: 14/768,099

(22) PCT Filed: Dec. 24, 2013
(86) PCT No.: PCT/KR2013/012094

§ 371 Date: Aug. 14, 2015

(30) Foreign Application Priority Data
Apr. 23, 2013 (KR) 10-2013-0044940
Jun. 26, 2013 (KR) 10-2013-0073788

(51) Int. Cl. G06Q 30/02

(52) U.S. Cl. CPC G06Q 30/0264

(57) ABSTRACT

The present invention discloses an advertisement providing system, a method therefor, and an apparatus applied for the same. That is, for each of two or more advertisement media, advertisement content corresponding to assigned advertisement content allocation quantities is provided, the advertisement content is received on each of the two or more advertisement media and whether the advertisement content allocation quantities are exhausted is acknowledged, and, for each of the two or more advertisement media, the advertisement content allocation quantities for each of the two or more advertisement media are assigned based on the advertisement content exhaustion quantities acknowledged in two or more correlated time intervals, thereby guaranteeing the advertisement content quantities required differently by the advertisement media, and guaranteeing the quantities agreed on by an advertiser related with the provision of the advertisement content.

### TECHNICAL FIELD

The present invention relates to a method of setting advertisement content allocation ratios among advertisement media based on advertisement content exhaustion quantities acknowledged for the respective advertisement media to adjust advertisement content allocation quantities for the advertisement media.

### BACKGROUND ART

As mobile devices capable of executing various applications such as smartphones are widely spread recently, a mobile advertisement service which utilizes an execution screen of an application as an advertisement medium for displaying the advertisement content is realized.

Also, in the mobile device, a web page, which can be connected to via the mobile device, as well as the application can be utilized as the advertisement medium for displaying the advertisement content.

According to such mobile advertisement service, advertisement content is requested via the application or the web page serving as the advertisement media, and the advertisement content, which is received from an advertisement providing apparatus according to the request, is displayed on a service area of the corresponding advertisement medium.

In this regard, the advertisement providing apparatus has to satisfy the advertisement content quantities which are differently requested for multiple advertisement media, and, in order to accomplish this, a method of dividing an advertisement content total quantity registered by advertisers to advertisement content allocation quantities for respective advertisement media, and assigning and managing the divided result is required.

### DISCLOSURE OF THE INVENTION

The present invention is proposed by considering the aforementioned matters, and the objectives of the present invention are to, for each of two or more advertisement media, provide advertisement content corresponding to assigned advertisement content allocation quantities, receive the advertisement content on each of the two or more advertisement media, acknowledge whether the advertisement content allocation quantities are exhausted, and, for each of the two or more advertisement media, assign the advertisement content allocation quantities for each of the two or more advertisement media based on the advertisement content exhaustion quantities acknowledged in two or more correlated time intervals, thereby guaranteeing the advertisement content quantities required differently by the advertisement media, and guaranteeing the quantities agreed on by an advertiser related with the provision of the advertisement content.

Also, other objectives of the present invention are to provide, for each of two or more advertisement media, advertisement content corresponding to set advertisement content allocation quantities, to receive the advertisement content on each of the two or more advertisement media and acknowledge whether the advertisement content allocation quantities are exhausted, and set the advertisement content allocation quantities for each of the two or more advertisement media based on the advertisement content exhaustion quantities acknowledged for each of the two or more advertisement media, thereby easily exhausting the advertisement content exhaustion quantities which are agreed on by the advertisers.

An advertisement providing apparatus according to a first aspect of the present invention for accomplishing the objects is characterized in comprising: a providing unit which, for each of two or more advertisement media, provides advertisement content corresponding to assigned advertisement content allocation quantities; an acknowledging unit which acknowledges whether the advertisement content is received and the advertisement content allocation quantities are exhausted on each of the two or more advertisement media; and a control unit which, for each of the two or more advertisement media, assigns the advertisement content allocation quantities for each of the two or more advertisement media based on the advertisement content exhaustion quantities acknowledged in two or more correlated time intervals.

More specifically, the advertisement providing apparatus characterized in that it further comprises an assigning unit which assigns the advertisement content allocation quantities for each of the two or more advertisement media based on advertisement content allocation ratios set among the two or more advertisement media, and the control unit sets the advertisement content allocation ratios based on the advertisement content exhaustion quantities acknowledged for each of the two or more advertisement media, such that the assigning unit assigns the advertisement content allocation quantities.

More specifically, the advertisement providing apparatus is characterized in that the advertisement content allocation ratios are set based on magnitudes of advertisement content exhaustion scores calculated for each of the two or more advertisement media, and the control unit adds, for each of the two or more advertisement media, the exhaustion quantities of the advertisement content acknowledged in the two or more time intervals to calculate the advertisement content exhaustion scores for each of the two or more advertisement media.

More specifically, the advertisement providing apparatus is characterized in that different weights according to a time sequence of the two or more time intervals are given to each of the advertisement content exhaustion quantities acknowledged in the two or more time intervals, and the control unit gives a higher weight for an advertisement content exhaustion quantity, which is acknowledged most recently among the advertisement content exhaustion quantities acknowledged in the two or more time intervals, than for the advertisement content exhaustion quantities acknowledged in the rest time intervals to calculate the advertisement content exhaustion scores.

More specifically, the advertisement providing apparatus is characterized in that the control unit controls the assigning unit to assign a greater advertisement content allocation quantity for the advertisement media with the biggest magnitude of the advertisement content exhaustion scores among the two or more advertisement media, than for the rest advertisement media.

More specifically, the advertisement providing apparatus is characterized in that the advertisement providing apparatus further comprises an updating unit which, when the acknowledging unit acknowledges that advertisement content allocation quantities are exhausted on each of the two or more advertisement media, accumulates to update the advertisement content exhaustion quantities exhausted on the two or more advertisement media, and the control unit assigns advertisement content remaining quantities, which correspond to advertisement content exhaustion quantities subtracted from an advertisement content total quantity, as the advertisement content allocation quantities for the two or more advertisement media.

An advertisement providing method according to a second aspect of the present invention for accomplishing the objects is characterized in comprising: a receiving step in which a plurality of user devices, for each of two or more advertisement media, receive advertisement content corresponding to assigned advertisement content allocation quantities from an advertisement providing apparatus; an acknowledging step in which the advertisement providing apparatus acknowledges whether the advertisement content is received and the advertisement content allocation quantities are exhausted on each of the two or more advertisement media; and a controlling step in which the advertisement providing apparatus assigns, for each of the two or more advertisement media, the advertisement content allocation quantities for each of the two or more advertisement media based on the advertisement content exhaustion quantities acknowledged in two or more correlated time intervals.

An operating method for an advertisement providing apparatus according to a third aspect of the present invention for accomplishing the objects is characterized in comprising: a providing step for providing, for each of two or more advertisement media, advertisement content corresponding to assigned advertisement content allocation quantities; an acknowledging step for acknowledging whether the advertisement content is received and the advertisement content allocation quantities are exhausted on each of the two or more advertisement media; and a controlling step for, for each of the two or more advertisement media, assigning the advertisement content allocation quantities for each of the two or more advertisement media based on the advertisement content exhaustion quantities acknowledged in two or more correlated time intervals. More specifically, the advertisement providing method is characterized in that the method further comprises an assigning step for assigning the advertisement content allocation quantities for each of the two or more advertisement media based on advertisement content allocation ratios set among the two or more advertisement media, and in the controlling step the advertisement content allocation ratios are set based on the advertisement content exhaustion quantities acknowledged for each of the two or more advertisement media, such that the advertisement content allocation quantities are assigned in the assigning step.

More specifically, the advertisement content allocation ratios are set based on magnitudes of advertisement content exhaustion scores calculated for each of the two or more advertisement media, and the controlling step is characterized in that it adds, for each of the two or more advertisement media, the exhaustion quantities of the advertisement content acknowledged in the two or more time intervals to calculate the advertisement content exhaustion scores for each of the two or more advertisement media.

More specifically, different weights according to a time sequence of the two or more time intervals are given to each of the advertisement content exhaustion quantities acknowledged in the two or more time intervals, and the controlling step is characterized in that it gives a higher weight for an advertisement content exhaustion quantity, which is acknowledged most recently among the advertisement content exhaustion quantities acknowledged in the two or more time intervals, than for the advertisement content exhaustion quantities acknowledged in the rest time intervals to calculate the advertisement content exhaustion scores.

More specifically, the controlling step is characterized in that, in the assigning step, a greater advertisement content allocation quantity is assigned for the advertisement media with the biggest magnitude of the advertisement content exhaustion scores among the two or more advertisement media, than for the rest advertisement media. More specifically, the method is characterized in that it further comprises an updating step in which, when in the acknowledging step it is acknowledged that the advertisement content allocation quantities are exhausted on each of the two or more advertisement media, the advertisement content exhaustion quantities exhausted on the two or more advertisement media are accumulated and updated, and in the controlling step, advertisement content remaining quantities, which correspond to advertisement content exhaustion quantities subtracted from an advertisement content total quantity, are assigned as the advertisement content allocation quantities for the two or more advertisement media.

An advertisement providing system according to a fourth aspect of the present invention for accomplishing the objects is characterized in comprising: a plurality of user devices which, for each of two or more advertisement media, receive advertisement content corresponding to assigned advertisement content allocation quantities from an advertisement providing apparatus; and the advertisement providing apparatus which acknowledge whether the advertisement content is received and the advertisement content allocation quantities are exhausted on each of the two or more advertisement media; and assigns, for each of the two or more advertisement media, the advertisement content allocation quantities for each of the two or more advertisement media based on the advertisement content exhaustion quantities acknowledged in two or more correlated time intervals.

An advertisement providing apparatus according to a fifth aspect of the present invention for accomplishing the objects is characterized in comprising: a providing unit which, for each of two or more advertisement media, provides advertisement content corresponding to set advertisement content allocation quantities; an acknowledging unit which acknowledges whether the advertisement content is received and the advertisement content allocation quantities are exhausted on each of the two or more advertisement media; and a control unit which, for each of the two or more advertisement media, sets the advertisement content allocation quantities for each of the two or more advertisement media based on the advertisement content exhaustion quantities acknowledged for each of the two or more advertisement media.

More specifically, the advertisement providing apparatus is characterized in that it further comprises a setting unit which sets the advertisement content allocation quantities for each of the two or more advertisement media, and the setting unit sets the advertisement content allocation quantities for each of the two or more advertisement media based on advertisement content allocation ratios sets among the two or more advertisement media.

More specifically, the control unit is characterized in that it sets the advertisement content allocation ratios based on the advertisement content exhaustion quantities acknowledged for each of the two or more advertisement media such that setting unit sets the advertisement content allocation quantities.

More specifically, the advertisement providing apparatus is characterized in that it further comprises: an updating unit which, when the acknowledging unit acknowledges that the advertisement content allocation quantities are exhausted on each of the two or more advertisement media, accumulates to update the advertisement content exhaustion quantities exhausted on the two or more advertisement media, and the control unit divides advertisement content remaining quantities, which correspond to the accumulated advertisement content exhaustion quantities subtracted from an advertisement content total quantity agreed on by an advertiser, to set the advertisement content allocation quantities for the two or more advertisement media. More specifically, compensation coefficients calculated for each of the two or more advertisement media are applied to the advertisement content allocation quantities set for each of the two or more advertisement media, and the control unit is characterized in that it applies the compensation coefficients to each of the advertisement content remaining quantities divided for the two or more advertisement media to set the advertisement content allocation quantities for each of the two or more advertisement media.

More specifically, the compensation coefficients calculated for each of the two or more advertisement media are characterized in that they are calculated based on ratios of the advertisement content exhaustion quantities acknowledged for each of the two or more advertisement media with respect to advertisement content provision quantities provided for each of the two or more advertisement media.

An advertisement providing method according to a sixth aspect of the present invention for accomplishing the objects is characterized in comprising: characterized in comprising: a receiving step in which a plurality of terminals receive, for each of two or more advertisement media, advertisement content provided from an advertisement providing apparatus; an acknowledging step in which the advertisement providing apparatus acknowledges whether the advertisement content is received and the advertisement content allocation quantities set for each of two or more advertisement media are exhausted; and a controlling step in which the advertisement providing apparatus sets the advertisement content allocation quantities for each of the two or more advertisement media based on the advertisement content exhaustion quantities acknowledged for each of two or more advertisement media.

An operating method for an advertisement providing apparatus according to a seventh aspect of the present invention for accomplishing the objects is characterized in comprising: a providing step for providing, for each of two or more advertisement media, advertisement content corresponding to set advertisement content allocation quantities; an acknowledging step for acknowledging whether the advertisement content is received and the advertisement content allocation quantities are exhausted on each of the two or more advertisement media; and a controlling step for setting, for each of the two or more advertisement media, the advertisement content allocation quantities for each of the two or more advertisement media based on the advertisement content exhaustion quantities acknowledged for each of the two or more advertisement media. More specifically, the operating method is characterized in that it further comprises a setting step in which the advertisement content allocation quantities for each of the two or more advertisement media are set, and in the setting step, the advertisement content allocation quantities for each of the two or more advertisement media are set based on advertisement content allocation ratios sets among the two or more advertisement media.

More specifically, in the controlling step, the advertisement content allocation ratios are characterized in that they are set based on the advertisement content exhaustion quantities acknowledged for each of the two or more advertisement media such that the advertisement content allocation quantities are set in the setting step.

More specifically, the operating method is characterized in that it further comprises an updating step in which when it is acknowledged in the acknowledging step that the advertisement content allocation quantities are exhausted on each of the two or more advertisement media, the advertisement content exhaustion quantities exhausted on the two or more advertisement media are accumulated and updated, and in the controlling step, advertisement content remaining quantities, which correspond to the accumulated advertisement content exhaustion quantities subtracted from an advertisement content total quantity agreed on by an advertiser, are divided to set the advertisement content allocation quantities for the two or more advertisement media. More specifically, compensation coefficients calculated for each of the two or more advertisement media are applied to the advertisement content allocation quantities set for each of the two or more advertisement media, and in the controlling step, the compensation coefficients are characterized in that they are applied to each of the advertisement content remaining quantities divided for the two or more advertisement media to set the advertisement content allocation quantities for each of the two or more advertisement media.

More specifically, the compensation coefficients calculated for each of the two or more advertisement media are characterized in that they are calculated based on ratios of the advertisement content exhaustion quantities acknowledged for each of the two or more advertisement media with respect to advertisement content provision quantities provided for each of the two or more advertisement media.

An advertisement providing system according to an eighth aspect of the present invention for accomplishing the objects is characterized in comprising: a plurality of terminal devices which receive advertisement content provided by an advertisement providing apparatus for each of two or more advertisement media; and the advertisement providing apparatus which acknowledges whether the advertisement content is received and the advertisement content allocation quantities set for each of two or more advertisement media are exhausted on each of the two or more advertisement media, and sets the advertisement content allocation quantities for each of the two or more advertisement media based on the advertisement content exhaustion quantities acknowledged for each of two or more advertisement media.

By using an advertisement providing system, a method therefor, and an apparatus applied to the same according to one embodiment of the present invention, advertisement content allocation ratios among advertisement media are set based on the advertisement content exhaustion quantities acknowledged for the respective advertisement media to adjust the advertisement content allocation quantities, thereby maximally guaranteeing advertisement content provision guarantee ratios required by the respective advertisement media and guaranteeing the quantities agreed on by advertisers related with provision of the advertisement content.

Also, by using the advertisement providing system, the method therefor, and the apparatus applied to the same according to another embodiment of the present invention, advertisement content allocation ratios among advertisement media are adjusted to be set based on the advertisement content exhaustion quantities acknowledged for the respective advertisement media, thereby maximally guaranteeing advertisement content provision guarantee ratios (Fill Rates) and selection ratios (Click Through Ratios) required by the respective advertisement media and easily exhausting the advertisement content exhaustion quantities agreed on by the advertisers.

### BRIEF DESCRIPTION OF THE DRAWINGS

FIG. 1 is a schematic block diagram of an advertisement providing system according to an embodiment of the present invention.

FIG. 2 is a schematic block diagram of an advertisement providing apparatus according to an embodiment of the present invention.

FIG. 3 is a schematic flowchart for illustrating operation flows in the advertisement providing system according to an embodiment of the present invention.

FIG. 4 is a schematic flowchart for illustrating operation flows in the advertisement providing apparatus according to an embodiment of the present invention.

FIG. 5 is a schematic block diagram of an advertisement providing system according to another embodiment of the present invention.

FIG. 6 is a schematic block diagram of an advertisement providing apparatus according to another embodiment of the present invention.

FIG. 7 is a schematic flowchart for illustrating operation flows in the advertisement providing system according to another embodiment of the present invention.

FIG. 8 is a schematic flowchart for illustrating operation flows in the advertisement providing apparatus according to another embodiment of the present invention.

### BEST MODE FOR CARRYING OUT THE INVENTION

Here, one embodiment of the present invention is described by referring to the appended figures.

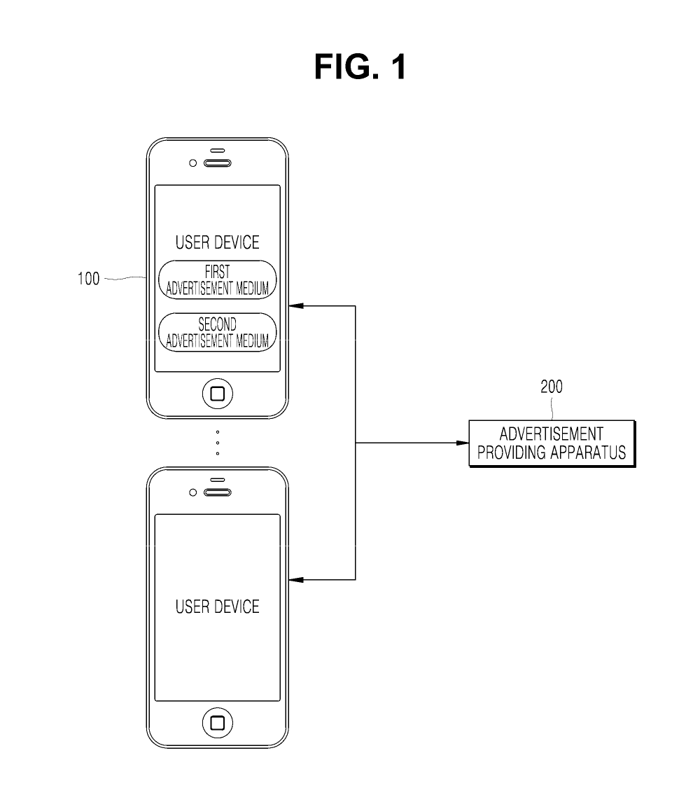

FIG. 1 is a diagram illustrating an advertisement providing system according to an embodiment of the present invention.

As shown in FIG. 1, advertisement providing system according to an embodiment of the present invention has a configuration comprising a plurality of user devices 100 which request to receive advertisement content corresponding to advertisement media; and an advertisement providing apparatus 200 which provides the advertisement content to the advertisement media according to the request from the user devices 100.

Here, the user device 100 refers to a mobile device for executing an application which is the advertisement media or connecting to a web page, and can include a smartphone, a tablet personal computer (PC), and a personal digital assistant (PDA), etc.; however, every apparatus, which is not limited to these and can execute an application serving as the advertisement media or connect to the web page, can be included in the user devices.

Also, the advertisement providing apparatus 200 refers to an advertisement server for providing the advertisement content to the advertisement media run on the user devices 100 and it can extract and provide the advertisement content allocated for the advertisement media according to the request received from the user devices 100. Meanwhile, according to an embodiment of the present invention, the advertisement providing apparatus 200 operates to guarantee provision guarantee ratios for the advertisement content set for the respective advertisement media.

Here, the provision guarantee ratios refer to a ratio between the number of advertisement content requests received to be related with specific advertisement media and advertisement content quantities (Impressions) which can be substantially provided.

provision guarantee ratios (Fill Rate)=advertisement content quantities (Impression)/advertisement content request number (Request)*100% [Mathematical expression 1]

*In this regard, it is possible to guarantee the provision guarantee ratios by possessing advertisement content indefinitely and providing the advertisement content whenever the advertisement media require; however, as a matter of fact, reception time points of the advertisement content requests received from the advertisement media cannot be predicted, and, more specifically, it is not possible to possess the advertisement content indefinitely.

*Therefore, it is not possible to guarantee all provision guarantee ratios set for the respective advertisement media within restricted quantities of the advertisement content in providing the advertisement content to a plurality of advertisement media, and, even for the advertisement content requests received from the advertisement media, reception time points and requested content quantities cannot be predicted, which makes it hard to assign advertisement content allocation quantities for the respective advertisement media.

So, according to one embodiment of the present invention, a method of setting advertisement content allocation ratios among advertisement media based on advertisement content exhaustion quantities acknowledged for the respective advertisement media is proposed, and this method is described in detail in the following. Meanwhile, although the advertisement content is provided for a plurality of advertisement media according to an embodiment of the present invention, the advertisement media are confined to a first advertisement medium and a second advertisement medium in the following for convenience of description.

Here, the first advertisement medium and the second advertisement medium, for example, refer to an application or a web page which are different advertisement media utilized as the advertisement media by the user devices 100, respectively.

And the advertisement content provided by the advertisement providing apparatus 200 refers to an advertisement product which is registered by an advertiser to be provided to both the application and the web page.

Also, the advertisement content total quantity which is referred to in the following represents the quantity assigned by the advertiser related to the provision of the advertisement content during a registration of the advertisement media by the advertiser, and refers to the advertisement content provision number which is to be guaranteed to be provided both for the first advertisement medium and the second advertisement medium.

Also, the advertisement content allocation quantities assigned for each of the first advertisement medium and the second advertisement medium is assigned by dividing the aforementioned advertisement content total quantity and represents the advertisement content provision number which can be provided according to the advertisement content requests received from the respective advertisement media. The user device 100 performs a function of acquiring and displaying the advertisement content.

More specifically, the user device 100 requests to receive the advertisement content from the advertisement providing apparatus 200 through software development kits (SDK) installed on the respective advertisement media according to an execution of the first advertisement medium or the second advertisement medium, and displays the received advertisement content on an advertisement display area of an execution screen of the application.

While doing so, the user device 100 displays the received advertisement content according to various display methods such as an offerwall method in which a plurality of advertisements are listed, a foreground advertisement method in which the advertisement content is displayed in front of a middle execution screen executing the advertisement media application, a banner method in which the advertisement content is displayed through inserted banners, and an icon method in which the advertisement content is displayed as icons.

Also, the user device 100 performs a function of notifying the reception of the advertisement content.

More specifically, the user device 100 can enable the advertisement providing apparatus 200 to acknowledge whether the advertisement content allocation quantities for each of the first advertisement medium and the second advertisement medium are exhausted by notifying the advertisement providing apparatus 200 of the fact that the advertisement content, which is provided from the advertisement providing apparatus 200 related to the first advertisement medium or the second advertisement medium, is normally received.

For example, if a type of the advertisement content provided from the advertisement providing apparatus 200 is a CPM (Cost Per Mile, Cost Per thousand iMperssion, Cost Per Millennium) advertisement, and if the advertisement content provided from the advertisement providing apparatus 200 is received and normally displayed, the user device 100 notifies to the advertisement providing apparatus 200 of this.

Also, if a type of the advertisement content provided from the advertisement providing apparatus 200 is a CPC(Cost Per Click) advertisement, and if the advertisement content provided from the advertisement providing apparatus 200 is received and displayed and a selection event (Click) of a user related to the displayed advertisement content is generated, the user devices 100 notifies the advertisement providing apparatus 200 of this.

Meanwhile, although the one embodiment of the present invention proposes a configuration in which the advertisement providing apparatus 200 acknowledges that the advertisement content is normally received and the advertisement content allocation quantities for the respective advertisement media are exhausted, a configuration in which a separate apparatus performs the corresponding functions and the advertisement providing apparatus 200 is interlinked with the advertisement providing apparatus 200 is also possible.

The advertisement providing apparatus 200 performs a function of assigning the advertisement content allocation quantities for the advertisement media.

More specifically, the advertisement providing apparatus 200 assigns advertisement content allocation quantities for each of the first advertisement medium and the second advertisement medium according to the advertisement content allocation ratios preset among the advertisement media.

While doing so, when the advertisement content allocation quantities are assigned for the first time, the advertisement providing apparatus 200 converts an advertisement period requested by the advertiser to assigned time intervals (e.g.: one minute durations) and divides the advertisement content total quantity by the result value of the conversion from the advertisement period to the time intervals to assign them as advertisement content allocation quantities for both of the first advertisement medium and the second advertisement medium corresponding to the respective time intervals in order to prevent the advertisement content total quantity from being assigned unevenly to a specific time interval.

Meanwhile, when the advertisement content allocation quantities are reassigned after the initial assignment of the advertisement content allocation quantities, an assigning unit 210 converts the remaining advertisement period to the assigned time intervals (e.g.: one minute durations) and divides the advertisement content remaining quantities, which are not exhausted by the first advertisement medium and the second advertisement medium, by the result value of the conversion from the remaining advertisement period to the time intervals to assign them as advertisement content allocation quantities for both of the first advertisement medium and the second advertisement medium corresponding to the respective time intervals.

Also, the advertisement providing apparatus 200 performs a function of providing the advertisement content for the respective advertisement media.

More specifically, when the advertisement content request for the first advertisement medium or the second advertisement medium is received from a plurality of user devices 100 after the advertisement content allocation quantities for each of the first advertisement medium and the second advertisement medium are assigned, the advertisement providing apparatus 200 extracts the advertisement content corresponding to the advertisement content allocation quantity of the corresponding advertisement medium and provides it to the user devices 100.

Also, the advertisement providing apparatus 200 performs a function of acknowledging whether the advertisement content allocation quantities for the respective advertisement media are exhausted.

More specifically, the advertisement providing apparatus 200 acknowledges whether each of the first advertisement medium and the second advertisement medium normally received the advertisement content which was provided during the most recent time period for every assigned time intervals (e.g.: one minute durations) and acknowledges exhaust states of the advertisement content allocation quantities for each of the first advertisement medium and the second advertisement medium.

While doing so, the advertisement providing apparatus 200 acknowledges whether the advertisement content allocation quantities for each of the first advertisement medium and the second advertisement medium are normally exhausted by being notified by the user devices 100 of the fact that the advertisement content which is provided related to the first advertisement medium or the second advertisement medium is normally received.

Also, the advertisement providing apparatus 200 performs a function of accumulating the advertisement content allocation quantities for the respective advertisement media. More specifically, when the advertisement content allocation quantities for each of the first advertisement medium and the second advertisement medium are acknowledged to be exhausted for every time intervals (e.g.: one minute durations), the advertisement providing apparatus 200 accumulates and updates the advertisement content exhaustion quantities exhausted by the first advertisement medium and the second advertisement medium.

Also, the advertisement providing apparatus 200 performs a function of setting the advertisement content allocation ratios among advertisement media.

More specifically, the advertisement providing apparatus 200 sets the advertisement content allocation ratios among the advertisement media by using the advertisement content exhaustion quantities acknowledged for each of the first advertisement medium and the second advertisement medium during a plurality of time intervals (for example: first time interval, second time interval, and third time interval) and adjusts the advertisement content allocation quantities assigned for the respective advertisement media.

While doing so, the advertisement providing apparatus 200 calculates advertisement content exhaustion scores for each of the first advertisement medium and the second advertisement medium by adding the advertisement content exhaustion quantities acknowledged during the time intervals (for example: first time interval, second time interval, and third time interval) in order to set the advertisement content allocation ratios, and can set the advertisement content allocation ratios by comparing the exhaustion scores calculated for each of the first advertisement medium and the second advertisement medium with each other.

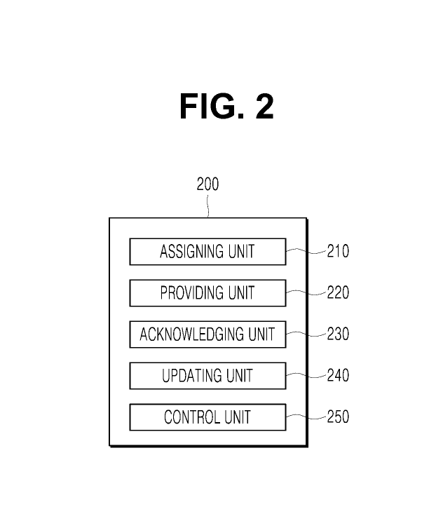

In the following, the configuration of the advertisement providing apparatus 200 according to an embodiment of the present invention is described in detail by referring to FIG. 2.

That is, the advertisement providing apparatus 200 according to an embodiment of the present invention can have a configuration comprising: an assigning unit 210 which assigns the advertisement content allocation quantities based on the advertisement content allocation ratios among the advertisement media, a providing unit 220 for providing the advertisement content, an acknowledging unit 230 for acknowledging the exhaustion quantities of the advertisement content, an updating unit 240 for accumulating and updating the advertisement content exhaustion quantities, and a control unit 250 for setting the advertisement content allocation ratios.

Here, respective configurations of the advertisement providing apparatus 200 comprising the aforementioned assigning unit 210, providing unit 220, acknowledging unit 230, updating unit 240, and control unit 250 can be implemented as a software module executed by a processor or as a combination thereof.

The assigning unit 210 performs a function of assigning the advertisement content allocation quantities for the advertisement media.

More specifically, the assigning unit 210 assigns advertisement content allocation quantities for each of the first advertisement medium and the second advertisement medium according to the advertisement content allocation ratios preset among the advertisement media.

While doing so, when the advertisement content allocation quantities are assigned for the first time, the assigning unit 210 divides the advertisement content total quantity registered by an advertiser into the same advertisement content allocation quantities for each of the first advertisement medium and the second advertisement medium and assigns the advertisement content allocation quantities.

For example, when a basic advertisement content allocation ratio set between the advertisement media is 5:5, and the advertisement content total quantity registered by the advertiser is 1000, the advertisement content allocation quantities for each of the first advertisement medium and the second advertisement medium are assigned as 500, respectively.

Here, the advertisement content total quantity should be exhausted during the advertisement period requested by the advertiser.

Therefore, in order to prevent the advertisement content total quantity from being assigned unevenly to a specific time interval, the assigning unit 210 converts an advertisement period to assigned time intervals (e.g.: one minute durations) according to the mathematical expression 2 and divides the advertisement content total quantity by the result value of the conversion from the advertisement period to the time intervals to assign them as advertisement content allocation quantities for both of the first advertisement medium and the second advertisement medium corresponding to the respective time intervals.

advertisement content allocation quantities of the first advertisement medium+advertisement content allocation quantities of the second advertisement medium=(advertisement content total quantity−accumulated advertisement content exhaustion quantities)/(remaining advertisement period/time intervals) [Mathematical expression 2]

For example, when the advertisement period requested by the advertiser is 100 minutes, the time interval for assigning the advertisement content allocation quantities is one minute, and the advertisement content allocation quantities registered by the advertiser is 1000, the advertisement content allocation quantities for the respective time intervals corresponding to all of the first advertisement medium and the second advertisement medium is 10 (1000/100).

Therefore, when the advertisement content allocation quantities are assigned for the first time, each 5 advertisement content allocation quantities obtained by dividing the advertisement content allocation quantities for the respective time intervals are assigned for the first advertisement medium and the second advertisement medium by reflecting the basic advertisement content allocation ratios set among the advertisement media.

Meanwhile, when the advertisement content allocation quantities are reassigned after the initial assignment of the advertisement content allocation quantities, the assigning unit 210 acknowledges the advertisement content remaining quantities, which are obtained by subtracting the advertisement content exhaustion quantities exhausted on each of the first advertisement medium and the second advertisement medium subtracted from the advertisement content total quantity, and divides the acknowledged advertisement content remaining quantities to assign them as the advertisement content allocation quantities corresponding to each of the first advertisement medium and the second advertisement medium.

For example, when an advertisement content allocation ratios set between the advertisement media is 5:5, the advertisement content total quantity registered by the initial advertiser is 1000, and the advertisement content remaining quantities after exhaustion of the advertisement content is acknowledged to be 600, the advertisement content allocation quantities for each of the first advertisement medium and the second advertisement medium are assigned as 300, respectively.

Here, as described above, the assigning unit 210 converts the remaining advertisement period to assigned time intervals (e.g.: one minute durations) according to the mathematical expression 2 and divides the advertisement content remaining quantities by the result value of the conversion from the remaining advertisement period to the time intervals to assign them as advertisement content allocation quantities for both of the first advertisement medium and the second advertisement medium corresponding to the respective time intervals.

For example, when the remaining advertisement period from the advertisement period requested by the advertiser is 60 minutes, the time interval for assigning the advertisement content allocation quantities is one minute, and the remaining advertisement content allocation quantities from the advertisement content total quantity registered by the advertiser is 600, the advertisement content allocation quantities for the respective time intervals corresponding to all of the first advertisement medium and the second advertisement medium is 10 (600/60).

Therefore, the advertisement content allocation ratio set between the advertisement media is 5:5 when the advertisement content allocation quantities are reassigned, each 5 advertisement content allocation quantities obtained by dividing the advertisement content allocation quantities for the respective time intervals are assigned for the first advertisement medium and the second advertisement medium.

The providing unit 220 performs a function of providing the advertisement content for the respective advertisement media.

More specifically, when the advertisement content request for the first advertisement medium or the second advertisement medium is received from a plurality of user devices 100 after the advertisement content allocation quantities for each of the first advertisement medium and the second advertisement medium are assigned, the providing unit 220 extracts the advertisement content corresponding to the advertisement content allocation quantity of the corresponding advertisement medium and provides it to the user devices 100.

The acknowledging unit 230 performs a function of acknowledging whether the advertisement content allocation quantities for the respective advertisement media are exhausted.

More specifically, the acknowledging unit 230 acknowledges whether each of the first advertisement medium and the second advertisement medium normally received the advertisement content which was provided during the most recent time period for every assigned time intervals (e.g.: one minute durations) and acknowledges exhaust states of the advertisement content allocation quantities for each of the first advertisement medium and the second advertisement medium.

While doing so, the acknowledging unit 230 acknowledges whether the advertisement content allocation quantities for each of the first advertisement medium and the second advertisement medium are normally exhausted by being notified by the user devices 100 of the fact that the advertisement content which is provided related to the first advertisement medium or the second advertisement medium is normally received. Meanwhile, the exhaust states for each of the first advertisement medium and the second advertisement medium can be acknowledged based on an advertisement content request received from the first advertisement medium and the second advertisement medium or the number of pieces of the advertisement content provided to the first advertisement medium and the second advertisement medium.

However, it can happen that the advertisement content is lost during an advertisement content provision process due to a network error and the first advertisement medium and the second advertisement medium cannot receive the advertisement content normally.

Therefore, according to one embodiment of the present invention, whether the advertisement content, which is provided in relation to the first advertisement medium or the second advertisement medium, is normally received is notified from the user devices 100 and whether the advertisement content allocation quantities are normally exhausted is acknowledged.

The updating unit 240 performs a function of tracking the advertisement content exhaustion quantities for the respective advertisement media.

More specifically, when the acknowledging unit 230 acknowledges that the advertisement content allocation quantities for each of the first advertisement medium and the second advertisement medium is exhausted for every time intervals (e.g.: one minute durations), the updating unit 240 accumulates and updates the advertisement content exhaustion quantities exhausted by the first advertisement medium and the second advertisement medium.

It is done to acknowledge the advertisement content remaining quantities not exhausted from the advertisement content total quantity at the time of reassigning the advertisement content allocation quantities after an initial assignment of the advertisement content allocation quantities.

The control unit 250 performs a function of setting the advertisement content allocation ratios among advertisement media.

More specifically, the control unit 250 sets the advertisement content allocation ratios among the advertisement media by using the advertisement content exhaustion quantities acknowledged for each of the first advertisement medium and the second advertisement medium during a plurality of time intervals (for example: first time interval, second time interval, and third time interval) and adjusts the advertisement content allocation quantities assigned for the respective advertisement media.

Here, there can be a correlation with respect to time points among a plurality of time intervals for acknowledging the advertisement content exhaustion quantities.

For example, when the first time interval is a recent one minute period, the second time interval comes to be the same time point on a previous day, and the third time interval can correspond to the same time point in a previous week.

While doing so, the control unit 250 calculates advertisement content exhaustion scores for each of the first advertisement medium and the second advertisement medium by adding the advertisement content exhaustion quantities acknowledged during the time intervals (for example: first time interval, second time interval, and third time interval) in order to set the advertisement content allocation ratios, and comes to set the advertisement content allocation ratios by comparing the exhaustion scores calculated for each of the first advertisement medium and the second advertisement medium with each other.

That is, the control unit 250 calculates advertisement content exhaustion scores by applying different weights (for example: a first weight, a second weight, and a third weight) to each of the advertisement content exhaustion quantities acknowledged during a plurality of time intervals (for example: a first time interval, a second time interval, and a third time interval) according to the mathematical expression 3 as follows.

advertisement content exhaustion scores=first weight*advertisement content exhaustion quantity during first time interval+second weight*advertisement content exhaustion quantity during second time interval+third weight*advertisement content exhaustion quantity during third time interval [Mathematical expression 3]

Here, the advertisement providing apparatus 200 applies a higher advertisement content exhaustion quantity for the advertisement content exhaustion quantities which are most recently acknowledged among the advertisement content exhaustion quantities acknowledged in a plurality of time intervals (for example: a first time interval, a second time interval, and a third time interval) than for the advertisement content exhaustion quantities acknowledged in the rest time intervals.

For example, when the first time interval, the second time interval, and the third time interval are listed in this sequence, and a first weight of 5 points is applied to the most recent first time period, a weight of 3 points can be provided to the second time interval while a weight of 2 points can be provided to the last third time interval.

The reason for calculating the advertisement content exhaustion scores by reflecting all of the advertisement content exhaustion quantities for a plurality of time intervals in this manner is to prevent a sporadic event, in which the advertisement content exhaustion quantity increases or decreases only for a specific time interval, from being dominantly reflected on assigning the advertisement content allocation quantities.

Also, the control unit 250 sets the advertisement content allocation ratios for assigning the advertisement content allocation quantities for each of the first advertisement medium and the second advertisement medium during the next time interval by comparing the advertisement content exhaustion scores calculated for each of the first advertisement medium and the second advertisement medium according to Mathematical expression 4 and Mathematical expression 5 with each other.

advertisement content allocation ratio (first advertisement medium)=advertisement content exhaustion score (first advertisement medium)/{advertisement content exhaustion score (first advertisement medium)+advertisement content exhaustion score (second advertisement medium)}*100 [Mathematical expression 4]

advertisement content allocation ratio (second advertisement medium)=advertisement content exhaustion score (second advertisement medium)/{advertisement content exhaustion score (first advertisement medium)+advertisement content exhaustion score (second advertisement medium)}*100 [Mathematical expression 5]

For example, when the advertisement content exhaustion score for the first advertisement medium is 35 points and the exhaustion score for the second advertisement medium is 15 points, the advertisement content allocation ratio for the first advertisement medium corresponding to the next time intervals can be set to 70%{35/(35+15)*100}, and the advertisement content allocation ratio for the second advertisement medium corresponding to the next time intervals can be set to 70%{35/(35+15)*100}.

Meanwhile, when no advertisement content exhaustion quantities are acknowledged for the first advertisement medium or the second advertisement medium or for all of the first advertisement medium and the second advertisement medium, the advertisement content allocation ratio between the first advertisement medium and the second advertisement medium is set to the basic allocation ratio (for example: 5:5), or the advertisement content allocation ratio between the first advertisement medium and the second advertisement medium set for the previous time interval can be maintained. Also, when the advertisement content allocation ratio for one of the first advertisement medium and the second advertisement medium is lower than the preassigned minimum allocation ratios (10%), the advertisement providing apparatus 200 can reset the advertisement content allocation ratio between the first advertisement medium and the second advertisement medium such that the advertisement content allocation ratio for the corresponding advertisement medium can be set to the minimum allocation ratio. As described above, by using an advertisement providing system according to one embodiment of the present invention, the advertisement content allocation ratios among advertisement media are set based on the advertisement content exhaustion quantities acknowledged for the respective advertisement media to adjust the advertisement content allocation quantities, thereby maximally guaranteeing advertisement provision guarantee ratio (Fill Rate) required by the respective advertisement media and guaranteeing the quantities agreed on by advertisers related to the provision of the advertisement content.

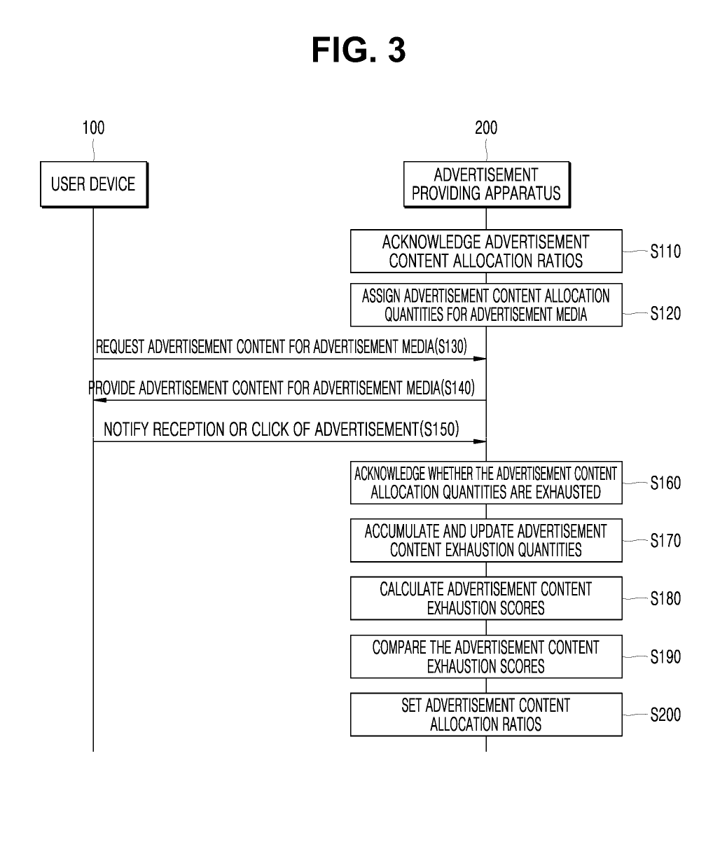

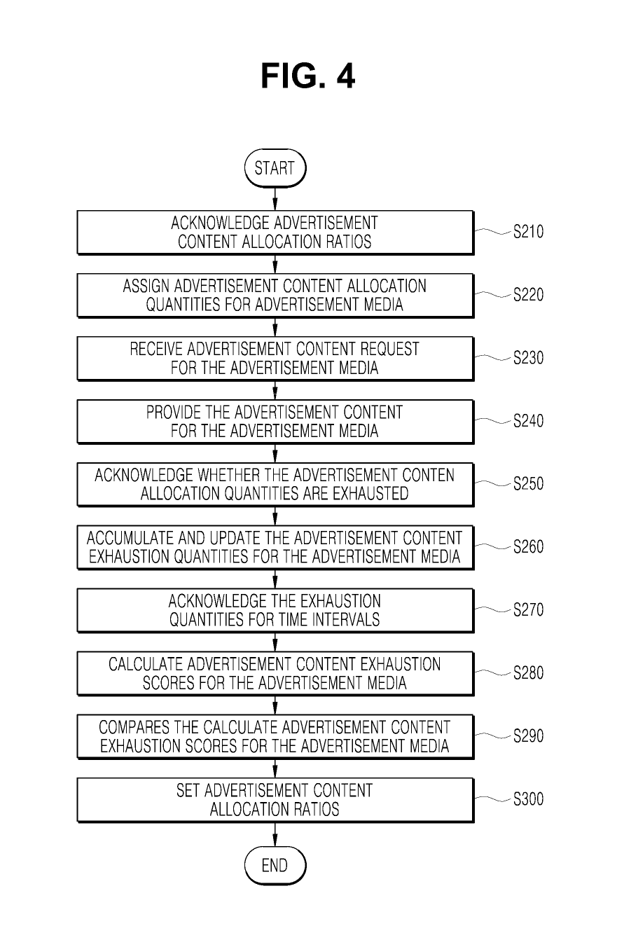

In the following, an advertisement service method according to an embodiment of the present invention is described by referring to FIG. 3 and FIG. 4. Here, the configurations described in the FIG. 1 and FIG. 2 are referred to by using corresponding reference numbers for the convenience of description.

First, operation flows in the advertisement providing system according to an embodiment of the present invention is described by referring to FIG. 3.

Most of all, the advertisement providing apparatus 200 assigns the advertisement content allocation quantities for each of the first advertisement medium and the second advertisement medium according to the advertisement content allocation ratios preset among the advertisement media (S110-S120).

While doing so, when the advertisement content allocation quantities are assigned for the first time, the advertisement providing apparatus 200 converts an advertisement period requested by the advertiser to assigned time intervals (e.g.: one minute durations) and divides the advertisement content total quantity by the result value of the conversion from the advertisement period to the time intervals to assign them as advertisement content allocation quantities for both of the first advertisement medium and the second advertisement medium corresponding to the respective time intervals in order to prevent the advertisement content total quantity from being assigned unevenly to a specific time interval.

Meanwhile, when the advertisement content allocation quantities are reassigned after the initial assignment of the advertisement content allocation quantities, an assigning unit 210 converts the remaining advertisement period to the assigned time intervals (e.g.: one minute durations) and divides the advertisement content remaining quantities, which are not exhausted by the first advertisement medium and the second advertisement medium, by the result value of the conversion from the remaining advertisement period to the time intervals to assign them as advertisement content allocation quantities for both of the first advertisement medium and the second advertisement medium corresponding to the respective time intervals.

Then, when the advertisement content request for the first advertisement medium or the second advertisement medium is received from a plurality of user devices 100 after the advertisement content allocation quantities for each of the first advertisement medium and the second advertisement medium are assigned, the advertisement providing apparatus 200 extracts the advertisement content corresponding to the advertisement content allocation quantity of the corresponding advertisement medium and provides it to the user devices 100 (S130-S140).

After doing so, the user device 100 can enable the advertisement providing apparatus 200 to acknowledge whether the advertisement content allocation quantities for each of the first advertisement medium and the second advertisement medium are exhausted by notifying the advertisement providing apparatus 200 of the fact that the advertisement content, which is provided from the advertisement providing apparatus 200 related to the first advertisement medium or the second advertisement medium, is normally received (S150).

Next, the advertisement providing apparatus 200 acknowledges whether each of the first advertisement medium and the second advertisement medium normally received the advertisement content which was provided during the most recent time period for every assigned time intervals (e.g.: one minute durations) and acknowledges exhaust states of the advertisement content allocation quantities for each of the first advertisement medium and the second advertisement medium (S160).

Also, when the advertisement content allocation quantities for each of the first advertisement medium and the second advertisement medium are acknowledged to be exhausted for every time intervals (e.g.: one minute durations), the advertisement providing apparatus 200 accumulates and updates the advertisement content exhaustion quantities exhausted by the first advertisement medium and the second advertisement medium (S170).

After doing so, the advertisement providing apparatus 200 sets the advertisement content allocation ratios among the advertisement media by using the advertisement content exhaustion quantities acknowledged for each of the first advertisement medium and the second advertisement medium during a plurality of time intervals (for example: first time interval, second time interval, and third time interval) and adjusts the advertisement content allocation quantities assigned for the respective advertisement media (S180-S200).

While doing so, the advertisement providing apparatus 200 calculates advertisement content exhaustion scores for each of the first advertisement medium and the second advertisement medium by adding the advertisement content exhaustion quantities acknowledged during the time intervals (for example: first time interval, second time interval, and third time interval) in order to set the advertisement content allocation ratios, and can set the advertisement content allocation ratios by comparing the exhaustion scores calculated for each of the first advertisement medium and the second advertisement medium with each other.

In the following, the operation of the advertisement providing apparatus 200 according to an embodiment of the present invention is described in detail by referring to FIG. 4. Most of all, the assigning unit 210 assigns the advertisement content allocation quantities for each of the first advertisement medium and the second advertisement medium according to the advertisement content allocation ratios preset among the advertisement media (S210-S220).

While doing so, when the advertisement content allocation quantities are assigned for the first time, the assigning unit 210 divides the advertisement content total quantity registered by an advertiser into the same advertisement content allocation quantities for each of the first advertisement medium and the second advertisement medium and assigns the advertisement content allocation quantities.

Here, in order to prevent the advertisement content total quantity from being assigned unevenly to a specific time interval, the assigning unit 210 converts an advertisement period requested by an advertiser to assigned time intervals (e.g.: one minute durations) and divides the advertisement content total quantity by the result value of the conversion from the advertisement period to the time intervals to assign them as advertisement content allocation quantities for both of the first advertisement medium and the second advertisement medium corresponding to the respective time intervals.

Meanwhile, when the advertisement content allocation quantities are reassigned after the initial assignment of the advertisement content allocation quantities, the assigning unit 210 acknowledges the advertisement content remaining quantities, which are obtained by subtracting the advertisement content exhaustion quantities exhausted on each of the first advertisement medium and the second advertisement medium subtracted from the advertisement content total quantity, and divides the acknowledged advertisement content remaining quantities to assign them as the advertisement content allocation quantities corresponding to each of the first advertisement medium and the second advertisement medium.

Here, the assigning unit 210 converts the remaining advertisement period to assigned time intervals (e.g.: one minute durations) and divides the advertisement content remaining quantities by the result value of the conversion from the remaining advertisement period to the time intervals to assign them advertisement content allocation quantities for both of the first advertisement medium and the second advertisement medium corresponding to the respective time intervals.

Then, when the advertisement content request for the first advertisement medium or the second advertisement medium is received from a plurality of user devices 100 after the advertisement content allocation quantities for each of the first advertisement medium and the second advertisement medium are assigned, the providing unit 220 extracts the advertisement content corresponding to the advertisement content allocation quantity of the corresponding advertisement medium and provides it to the user devices 100 (S230-S240).

Next, the acknowledging unit 230 acknowledges whether each of the first advertisement medium and the second advertisement medium normally received the advertisement content which was provided during the most recent time period for every assigned time intervals (e.g.: one minute durations) and acknowledges exhaust states of the advertisement content allocation quantities for each of the first advertisement medium and the second advertisement medium (S250).

While doing so, the acknowledging unit 230 acknowledges whether the advertisement content allocation quantities for each of the first advertisement medium and the second advertisement medium are normally exhausted by being notified by the user devices 100 of the fact that the advertisement content which is provided related to the first advertisement medium or the second advertisement medium is normally received. Then, when the acknowledging unit 230 acknowledges that the advertisement content allocation quantities for each of the first advertisement medium and the second advertisement medium is exhausted for every time intervals (e.g.: one minute durations), the updating unit 240 accumulates and updates the advertisement content exhaustion quantities exhausted by the first advertisement medium and the second advertisement medium (S260).

Furthermore, the control unit 250 sets the advertisement content allocation ratios among the advertisement media by using the advertisement content exhaustion quantities acknowledged for each of the first advertisement medium and the second advertisement medium during a plurality of time intervals (for example: first time interval, second time interval, and third time interval) and adjusts the advertisement content allocation quantities assigned for the respective advertisement media (S270-S300). While doing so, the control unit 250 calculates advertisement content exhaustion scores by applying different weights (for example: a first weight, a second weight, and a third weight) to each of the advertisement content exhaustion quantities acknowledged during a plurality of time intervals (for example: a first time interval, a second time interval, and a third time interval).

Also, the control unit 250 sets the advertisement content allocation ratios for assigning the advertisement content allocation quantities for each of the first advertisement medium and the second advertisement medium during the next time interval by comparing the advertisement content exhaustion scores calculated for each of the first advertisement medium and the second advertisement with each other.

As described above, by using an advertisement providing method according to one embodiment of the present invention, the advertisement content allocation ratios among advertisement media are set based on the advertisement content exhaustion quantities acknowledged for the respective advertisement media to adjust the advertisement content allocation quantities, thereby maximally guaranteeing advertisement provision guarantee ratio (Fill Rate) required by the respective advertisement media and guaranteeing the quantities agreed on by advertisers related to the provision of the advertisement content.

Here, another embodiment of the present invention is described by referring to the appended figures.

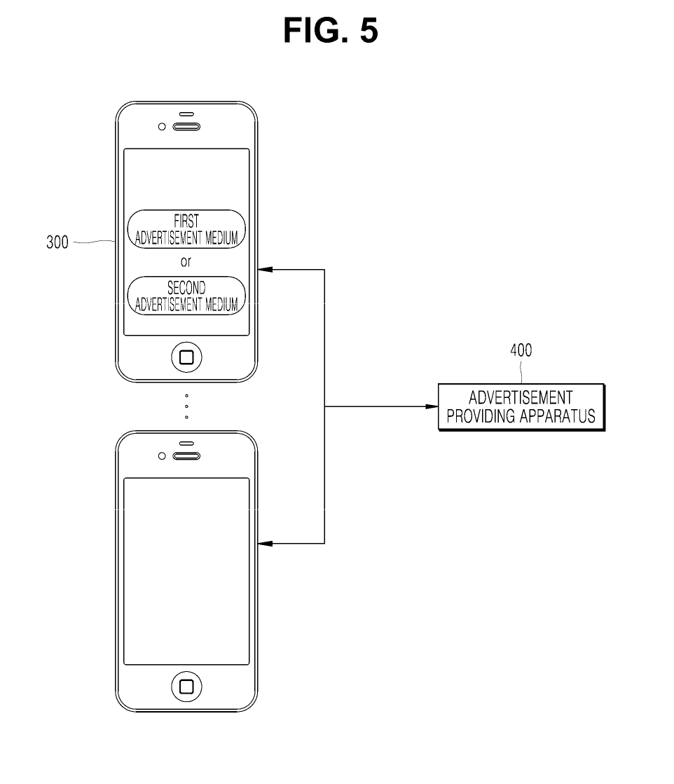

FIG. 5 is a diagram illustrating an advertisement providing system according to another embodiment of the present invention.

As shown in FIG. 5, the advertisement providing system according to another embodiment of the present invention has a configuration comprising a plurality of terminal devices 300 which request to receive the advertisement content corresponding to the advertisement media; and an advertisement providing apparatus 400 which provides the advertisement content to the advertisement media according to the request from the terminal devices 300.

Here, the terminal device 300 refers to a mobile device for executing an application which is the advertisement media or connecting to a web page, and can include a smartphone, a tablet personal computer (PC), and a personal digital assistant (PDA), etc.; however, every apparatus, which is not limited to these and can execute an application serving as the advertisement media or connect to the web page, can be included in the user devices.

Also, the advertisement providing apparatus 400 refers to an advertisement server for providing the advertisement content to the advertisement media operating on the terminal devices 300 and it can extract and provide the advertisement content allocated for the advertisement media when the request for the advertisement media is received from the user devices 300.

Meanwhile, according to another embodiment of the present invention, the advertisement providing apparatus 400 operates to set different advertisement content allocation quantities for the advertisement media in order to exhaust all of the advertisement content total quantity agreed on by the advertiser, such that the advertisement content can be provided within restricted quantities set for each of the advertisement media.

Similarly, the reason for setting different advertisement content allocation quantities for the respective advertisement media is to exhaust the advertisement content by reflecting the different advertisement content quantities requested by the advertisement media.

Here, the exhaustion of the advertisement content means that following operations are performed on the advertisement media related to the advertisement content provided from the advertisement providing apparatus 400.

For example, when a type of the advertisement content is CPM (Cost Per Mile, Cost Per thousand iMperssion, Cost Per Millennium), it means that the advertisement content provided from the advertisement providing apparatus 400 is normally received on the advertisement media and displayed.

Also, when the type of the advertisement content is CPC (Cost Per Click), it means that a selection event (Click) related to displayed advertisement content occurs while the advertisement content provided from the advertisement providing apparatus 400 is normally received on the advertisement media and displayed.

however, even when the advertisement content allocation quantities are set by applying the advertisement content remaining quantities of the respective advertisement media as described above, it can still happen that not all of the advertisement content allocation quantities set for the respective advertisement media is substantially exhausted.

For example, if the type of the advertisement content is CPM and even when the advertisement providing apparatus 400 provides the advertisement content for the advertisement media, it can happen that the advertisement media possibly fail to normally receive and display (expose) the advertisement content, and the provided advertisement content is not exhausted.

Also, if the type of the advertisement content is CPC and even when the advertisement content provided from the advertisement providing apparatus 400 is normally received and displayed, it can still happen that the selection event (Click) of a user related to the displayed advertisement content does not occur and the provided advertisement content is also not exhausted.

As shown above, even when the advertisement content is provided by applying different advertisement content remaining quantities to the respective advertisement media, the advertisement content total quantity agreed on by the advertiser cannot be exhausted as a whole since it can happen than the advertisement content exhaustion quantities exhausted by the advertisement media are not substantially applied as described above. Therefore, according to another embodiment of the present invention, a method of setting advertisement content allocation ratios among advertisement media based on advertisement content exhaustion quantities acknowledged for the respective advertisement media is proposed, and this method is described in detail in the following. Meanwhile, although the advertisement content is provided for a plurality of advertisement media according to another embodiment of the present invention, the advertisement media are confined to a first advertisement medium and a second advertisement medium in the following for convenience of description.

Here, the first advertisement medium and the second advertisement medium, for example, refer to an application or a web page which are different advertisement media serving as the advertisement media by the terminal devices 300, respectively.

And the advertisement content provided by the advertisement providing apparatus 400 refers to an advertisement product which is registered by an advertiser to be provided to both the application and the web page.

Also, the advertisement content total quantity found in the following refers to quantity information set by the advertiser during a registration of the advertisement content to the advertisement providing apparatus 400 by the advertiser, that is, the overall quantity of the advertisement content to be provided to the first advertisement medium and the second advertisement medium to be exhausted during the assigned advertisement period.

Also, the advertisement content allocation quantities set for each of the first advertisement medium and the second advertisement medium is set by dividing the aforementioned advertisement content total quantity and represents the advertisement content provision number which can be provided to the corresponding advertisement medium related to the advertisement content requests received from the respective advertisement media.

The terminal device 300 performs a function of acquiring and displaying the advertisement content.

More specifically, the terminal device 300 requests to receive the advertisement content from the advertisement providing apparatus 400 through software development kits (SDK) installed on the respective advertisement media according to an execution of the first advertisement medium or the second advertisement medium, and displays the received advertisement content on an advertisement display area of the corresponding advertisement content.

While doing so, the terminal device 300 displays the received advertisement content according to various display methods such as an offerwall method in which a plurality of advertisements are listed, a foreground advertisement method in which the advertisement content is displayed in front of a middle execution screen executing the advertisement media application, a banner method in which the advertisement content is displayed through inserted banners, and an icon method in which the advertisement content is displayed as icons.

Also, the terminal device 300 performs a function of notifying event information related to the advertisement content.

More specifically, the terminal device 300 can enable the advertisement providing apparatus 400 to acknowledge whether the advertisement content allocation quantities for each of the first advertisement medium and the second advertisement medium are exhausted by notifying the advertisement providing apparatus 400 of the event information related to the advertisement content provided from the advertisement providing apparatus 400 on each of the first advertisement medium or the second advertisement medium.

For example, if a type of the advertisement content provided from the advertisement providing apparatus 400 is a CPM (Cost Per Mile, Cost Per thousand iMperssion, Cost Per Millennium) advertisement, the terminal device 300 notifies the advertisement providing apparatus 400 of the event information representing that the advertisement content provided from the advertisement providing apparatus 400 is received and normally displayed.

Also, if a type of the advertisement content provided from the advertisement providing apparatus 400 is a CPC(Cost Per Click) advertisement, the terminal device 300 notifies the advertisement providing apparatus 400 of event information representing that the advertisement content provided from the advertisement providing apparatus 400 is received and displayed, and a selection event (Click) of a user related to the displayed advertisement content is generated.

Meanwhile, although the another embodiment of the present invention proposes a configuration in which the advertisement providing apparatus 400 receives the event information related to the advertisement content and acknowledges that the advertisement content is exhausted, a configuration in which a separate apparatus collects the event information and the advertisement providing apparatus 400 acknowledges this is also possible.

The advertisement providing apparatus 400 performs a function of setting the advertisement content allocation quantities for the advertisement media.

More specifically, when the advertisement content allocation quantities are set for the first time after the advertisement content is registered from an advertiser, the advertisement providing apparatus 400 sets the advertisement content allocation quantities for each of the first advertisement medium and the second advertisement medium according to the advertisement content allocation ratios preset among the advertisement media.

Meanwhile, when the advertisement content allocation quantities are reassigned after the initial assignment of the advertisement content allocation quantities, the advertisement providing apparatus 400 adjusts to set the advertisement content remaining quantities for each of the first advertisement medium and the second advertisement medium based on the advertisement content exhaustion quantities from the advertisement content total quantity exhausted in each of the first advertisement medium and the second advertisement medium.

Also, the advertisement providing apparatus 400 performs a function of providing the advertisement content for the respective advertisement media.

More specifically, when the advertisement content request for the first advertisement medium or the second advertisement medium is received from a plurality of terminal devices 300 after the advertisement content allocation quantities for each of the first advertisement medium and the second advertisement medium are set, the advertisement providing apparatus 200 extracts the advertisement content corresponding to the advertisement content allocation quantity of the corresponding advertisement medium and provides it to the terminal devices 300.

Also, the advertisement providing apparatus 400 performs a function of acknowledging whether the advertisement content allocation quantities for the respective advertisement media are exhausted.

The advertisement providing apparatus 400 acknowledges the advertisement content exhaustion quantities exhausted from the advertisement content allocation quantities for each of the first advertisement medium and the second advertisement medium by receiving the event information from the terminal devices 300 for every set time intervals and acknowledging whether the advertisement content provided to each of the first advertisement medium and the second advertisement medium is normally exhausted. Also, the advertisement providing apparatus 400 performs a function of accumulating the advertisement content allocation quantities for the respective advertisement media. More specifically, when the advertisement content allocation quantities for each of the first advertisement medium and the second advertisement medium are acknowledged to be exhausted for every time intervals (e.g.: one minute durations), the advertisement providing apparatus 400 accumulates and updates the advertisement content exhaustion quantities exhausted by the first advertisement medium and the second advertisement medium.

Also, the advertisement providing apparatus 400 performs a function of resetting the advertisement content allocation quantities based on the advertisement content exhaustion quantities for the respective advertisement media.

More specifically, when a resetting time point arrives after the initial setting of the advertisement content allocation quantities, the advertisement providing apparatus 400 acknowledges the advertisement content remaining quantities which correspond to the accumulated advertisement content exhaustion quantities acknowledged on the first advertisement medium and the second advertisement medium subtracted from the advertisement content total quantity agreed on by the advertiser.

And, the advertisement providing apparatus 400 divides the acknowledged advertisement content remaining quantities by a result value of the conversion from an advertisement remaining period to time intervals to calculate an overall advertisement content exhaustion target quantities to be exhausted in the next time interval.

Also, when the overall advertisement content exhaustion target quantities during the next time interval are calculated, the advertisement providing apparatus 400 calculates the advertisement content exhaustion target quantities during the next time interval for the respective advertisement media based on the ratio between the advertisement content exhaustion quantities on the first advertisement medium and the second advertisement medium.

Also, the advertisement providing apparatus 400 calculates a compensation coefficient for compensating for the advertisement content allocation quantities for the respective advertisement media based on the ratio of the advertisement content provision quantities with respect to substantial advertisement content exhaustion quantities acknowledged for each of the first advertisement medium and the second advertisement medium.

And, the advertisement providing apparatus 400 calculates the advertisement content allocation quantities by additionally applying the calculated compensation coefficient to the advertisement content exhaustion target quantities calculated for the respective advertisement media, and resets the result as the advertisement content allocation quantities during the next time interval for the respective advertisement media.

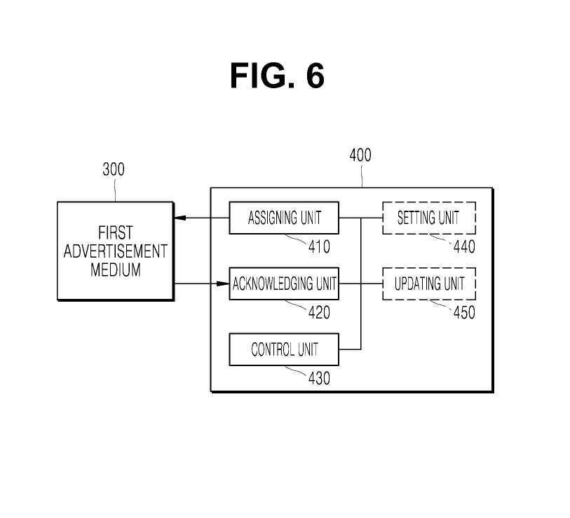

In the following, the configuration of the advertisement providing apparatus 400 according to another embodiment of the present invention is described in detail by referring to FIG. 6.

That is, the advertisement providing apparatus 400 according to another embodiment of the present invention can have a configuration comprising a providing unit 410 for providing the advertisement content, an acknowledging unit 420 for acknowledging exhaustion quantities of the advertisement content, and a control unit 430 for setting the advertisement content allocation quantities.

The advertisement providing apparatus 400 according to another embodiment of the present invention can have a configuration comprising, in addition to the aforementioned configuration, a setting unit 440 for setting the advertisement content allocation quantities and an updating unit 450 for accumulating and updating the advertisement content exhaustion quantities.

Here, the aforementioned respective configurations of the advertisement providing apparatus 400 comprising the providing unit 410, acknowledging unit 420, control unit 430, setting unit 440, and updating unit 450 can be implemented as a software module executed by a processor or as a combination thereof.

The setting unit 440 performs a function of setting the advertisement content allocation quantities for the advertisement media.

*More specifically, when the advertisement content allocation quantities are set for the first time after the advertisement content is registered from an advertiser, the setting unit 440 sets the advertisement content allocation quantities for each of the first advertisement medium and the second advertisement medium based on the advertisement content allocation ratios preset among the advertisement media under the control of the control unit 430.

While doing so, when the advertisement content allocation quantities are assigned for the first time, the setting unit 440 divides the advertisement content total quantity registered by an advertiser into the same advertisement content allocation quantities for each of the first advertisement medium and the second advertisement medium and sets the advertisement content allocation quantities.

For example, when a basic advertisement content allocation ratio set between the advertisement media is 5:5, and the advertisement content total quantity registered by the advertiser is 1000, the advertisement content allocation quantities for each of the first advertisement medium and the second advertisement medium are assigned as 500, respectively.

Here, the advertisement content total quantity should be exhausted during the advertisement period requested by the advertiser.

Therefore, in order to prevent the advertisement content total quantity from being set unevenly for a specific time interval, the setting unit 440 converts an advertisement period to set time intervals (e.g.: one minute durations) according to the mathematical expression 6 and divides the advertisement content total quantity by the result value of the conversion from the advertisement period to the time intervals to set them as the advertisement content allocation quantities for both of the first advertisement medium and the second advertisement medium corresponding to the respective time intervals.

advertisement content allocation quantities of first advertisement medium+advertisement content allocation quantities of second advertisement medium=(advertisement content total quantity−accumulated advertisement content exhaustion quantities)/(remaining advertisement period/time intervals) [Mathematical expression 6]

For example, when the advertisement period requested by the advertiser is 100 minutes, the time interval for setting the advertisement content allocation quantities is one minute, and the advertisement content allocation quantities registered by the advertiser is 1000, the advertisement content allocation quantities for the respective time intervals corresponding to all of the first advertisement medium and the second advertisement medium is 10 (1000/100).

Therefore, when the advertisement content allocation quantities are set for the first time, each 5 advertisement content allocation quantities obtained by dividing the advertisement content allocation quantities for the respective time intervals are set for the first advertisement medium and the second advertisement medium by applying the basic advertisement content allocation ratios set among the advertisement media. Meanwhile, when the advertisement content allocation quantities are reassigned after the initial assignment of the advertisement content allocation quantities, the setting unit 440 adjusts to set the advertisement content remaining quantities for each of the first advertisement medium and the second advertisement medium based on the advertisement content exhaustion quantities from the advertisement content total quantity exhausted in each of the first advertisement medium and the second advertisement medium, and detailed operations related to this are to be explained in the following.

The providing unit 410 performs a function of providing the advertisement content for the respective advertisement media.

More specifically, when the advertisement content request for the first advertisement medium or the second advertisement medium is received from a plurality of terminal devices 300 after the advertisement content allocation quantities for each of the first advertisement medium and the second advertisement medium are set, the providing unit 410 extracts the advertisement content corresponding to the advertisement content allocation quantity of the corresponding advertisement medium and provides it to the terminal devices 300.

The acknowledging unit 420 performs a function of acknowledging whether the advertisement content allocation quantities for the respective advertisement media are exhausted.

More specifically, the acknowledging unit 420 acknowledges the exhaust state of the advertisement content allocation quantities for each of the first advertisement medium and the second advertisement medium by acknowledging whether the advertisement content provided for each of the first advertisement medium and the second advertisement medium for every assigned time intervals (e.g.: one minute durations) is normally exhausted.

While doing so, the acknowledging unit 420 can acknowledge whether the advertisement content allocation quantities for each of the first advertisement medium and the second advertisement medium are normally exhausted by receiving generated event information related to the advertisement content provided in relation to the first advertisement medium or the second advertisement medium from a plurality of terminal devices 300.

Here, in case of the event information notified from the terminal devices 300 for example, advertisement content provision quantities corresponding to the quantities of the advertisement content received by the respective advertisement media, advertisement content exposure quantities corresponding to quantities of the advertisement content displayed (exposed) on the respective advertisement media, and advertisement content selection quantities corresponding to the quantities of the advertisement content selected (clicked on) on the respective advertisement media are included.

Meanwhile, the acknowledging unit 420 acknowledges the advertisement content exhaustion quantities exhausted from the advertisement content allocation quantities for each of the first advertisement medium and the second advertisement medium according to the advertisement content type (for example: CPM, CPC).

That is, the acknowledging unit 420 acknowledges the advertisement content exposure quantities corresponding to the quantities of the advertisement content displayed (exposed) on the respective advertisement media, when the type of the advertisement content is CPM, or the advertisement content selection quantities corresponding to the quantities of the advertisement content selected on the respective advertisement media, if the advertisement content type is CPC, as the advertisement content exhaustion quantities exhausted from the advertisement content allocation quantities.

The updating unit 450 performs a function of tracking the advertisement content exhaustion quantities for the respective advertisement media.

More specifically, when the acknowledging unit 420 acknowledges that the advertisement content allocation quantities for each of the first advertisement medium and the second advertisement medium are exhausted for every time intervals (e.g.: one minute durations), the updating unit 450 accumulates and updates the advertisement content exhaustion quantities exhausted by the first advertisement medium and the second advertisement medium.

While doing so, the updating unit 450 accumulates and updates not only the advertisement content exhaustion quantities for the respective advertisement media but also the event information (advertisement content provision quantities, advertisement content exposure quantities, advertisement content selection quantities) related to the respective advertisement media notified from a plurality of terminal devices 300. It is done to acknowledge the exhaust states of the advertisement content on the respective advertisement media along with the advertisement content remaining quantities not exhausted from the advertisement content total quantity at the time of reassigning the advertisement content allocation quantities after an initial assignment of the advertisement content allocation quantities.

The control unit 430 performs a function of setting the advertisement content allocation quantities based on the advertisement content exhaustion quantities for the respective advertisement media.

More specifically, the control unit 430 can control the setting unit 440 to reset the advertisement content allocation quantities for the respective advertisement media by calculating the advertisement content allocation quantities based on the advertisement content exhaustion quantities according to the advertisement content type acknowledged for each of the first advertisement medium and the second advertisement medium, when the resetting time point arrives after the initial setting of the advertisement content allocation quantities.

For example, the case in which the type of the advertisement content provided to the first advertisement medium and the second advertisement medium is CPM is as follows. Here, the advertisement content exhaustion quantities mean the advertisement content exposure quantities when the advertisement content is CPM.

Therefore, the control unit 430 acknowledges provision guarantee ratios (FR, Fill Late) for the respective advertisement media corresponding to the ratios between the advertisement content provision quantities and the advertisement content exposure quantities according to [Mathematical expression 7] and [Mathematical expression 8].

FR of first advertisement medium=daily accumulated advertisement content exposure quantities of first advertisement medium/daily accumulated advertisement content provision quantities of first advertisement medium [Mathematical expression 7]

FR of second advertisement medium=daily accumulated advertisement content exposure quantities of second advertisement medium/daily accumulated advertisement content provision quantities of second advertisement medium*100 [Mathematical expression 8]

Here, the FRs acknowledged for the respective advertisement media mean the probability of the advertisement content provision quantities provided for the respective advertisement media being substantially exposed, and the FR is set to 100% when no advertisement content exposure quantity exists.

Also, the control unit 430 calculates the overall advertisement content exposure target quantities during the next time interval (for example: 1 minute) by dividing the advertisement content remaining quantities, which correspond to the accumulated advertisement content exposure quantities acknowledged for the first advertisement medium and the second advertisement medium from the advertisement content total quantity agreed on by the advertiser, by the result value of the conversion from the advertisement remaining period to the time intervals according to the mathematical expression 9.

overall (first advertisement medium+second advertisement medium) advertisement content exposure target quantities during the next time interval=advertisement content total quantity−(accumulated advertisement content exposure quantities of first advertisement medium+accumulated advertisement content exposure quantities of second advertisement medium)/time intervals converted from advertisement remaining period [Mathematical expression 9]

Also, when the overall advertisement content exposure target quantities during the next time interval are calculated, the control unit 430 calculates the advertisement content exposure target quantities during the next time interval for the respective advertisement media based on the ratio between the advertisement content exposure quantities on the first advertisement medium and the second advertisement medium according to Mathematical expression 10 and Mathematical expression 11.

advertisement content exposure target quantities of first advertisement medium during next time interval=daily accumulated advertisement content exposure quantities of first advertisement medium/(daily accumulated advertisement content exposure quantities of first advertisement medium+daily accumulated advertisement content exposure quantities of second advertisement medium)*overall (first advertisement medium+second advertisement medium) advertisement content exposure target quantities during next time interval [Mathematical expression 10]

advertisement content exposure target quantities of second advertisement medium during next time interval=overall (first advertisement medium+second advertisement medium) advertisement content exposure target quantities during next time interval−advertisement content exposure target quantities of first advertisement medium during next time interval [Mathematical expression 11]

And, after the advertisement content exposure target quantities for the respective advertisement media are calculated for the next time interval, the control unit 430 calculates the advertisement content allocation quantities during the next time interval for the respective advertisement media by additionally applying the compensation coefficient of 1/FR*100 to the advertisement content exposure target quantities of the respective advertisement media according to Mathematical expression 12 and Mathematical expression 13.

advertisement content allocation quantities of first advertisement medium during next time interval=advertisement content exposure target quantities of first advertisement medium during next time interval*(1/FR of first advertisement medium*100) [Mathematical expression 12]

advertisement content allocation quantities of second advertisement medium during next time interval=advertisement content exposure target quantities of second advertisement medium during next time interval*(2/FR of second advertisement medium*100) [Mathematical expression 13]

Here, the compensation coefficient of 1/FR*100 is applied for compensating for the difference between the advertisement content exposure target quantities calculated for the respective advertisement media and the advertisement content exposure quantities substantially acknowledged for the advertisement media.

That is, if the advertisement content allocation quantities for each of the respective advertisement media during the next time interval are set to be equal to the precalculated advertisement content exposure target quantities, even when the advertisement content is provided for the number of times corresponding to the advertisement content allocation quantities, it can happen that the advertisement content exposure quantities substantially acknowledged for the respective advertisement media do not reach the advertisement content exposure target quantities. For example, when the advertisement content allocation quantity for a specific advertisement medium is set to 10 to be the same as the advertisement content exposure target quantity and FR of the specific advertisement medium is acknowledged to be 80%, this means that only 8 pieces of advertisement content are exposed on the specific advertisement medium as a result of the provision of 10 pieces of advertisement content to the specific advertisement medium.

In this case, the probability of the rest two pieces of advertisement content being exposed to the specific advertisement medium can be increased by setting the advertisement content allocation quantities to be greater than the advertisement content exposure target quantities.

Therefore, when FR, that is the compensation coefficient (1/FR*100) reflecting the FR acknowledged by the specific advertisement medium, is smaller than 100% (80%), the advertisement content quantities for compensating for the small FR (20%) can be calculated and added to the calculated advertisement content exposure target quantities, such that the number of pieces of the advertisement content corresponding to the advertisement content exposure target quantities are finally exposed on the corresponding advertisement medium.

As another example, the case in which the type of the advertisement content provided to the first advertisement medium and the second advertisement medium is CPC is as follows.

Here, the advertisement content exhaustion quantities mean the advertisement content selection quantities when the advertisement content is CPC.

Here, the advertisement providing apparatus 400 acknowledges the FRs for the respective advertisement media according to Mathematical expression 7 and Mathematical expression 8 while acknowledging selection ratios (CTR, Click Through Ratio) for the respective advertisement media corresponding to the ratios between the advertisement content exposure quantities and the advertisement content selection quantities according to Mathematical expression 14 and Mathematical expression 15.

CTR of first advertisement medium=daily accumulated advertisement content selection quantities of first advertisement medium/daily accumulated advertisement content exposure quantities of first advertisement medium*100 [Mathematical expression 14]

CTR of second advertisement medium=daily accumulated advertisement content selection quantities of first advertisement medium/daily accumulated advertisement content exposure quantities of second advertisement medium*100 [Mathematical expression 15]

Here, the CTRs acknowledged for the respective advertisement media mean the probability of the advertisement content exposure quantities being substantially exposed on the respective advertisement media, and a mean CTR for advertisement content corresponding to the same business is applied, when the advertisement content exposure quantities do not exists, while a minimum CRT for the advertisement content corresponding to the same business is applied, when the advertisement content selection quantities do not exist.

Also, the control unit 430 calculates the overall advertisement content exposure target quantities during the next time interval (for example: 1 minute) by dividing the advertisement content remaining quantities, which correspond to the accumulated advertisement content selection quantities acknowledged for the first advertisement medium and the second advertisement medium from the advertisement content total quantity agreed on by the advertiser, by the result value of the conversion from the advertisement remaining period to the time intervals according to the mathematical expression 16.

overall (first advertisement medium+second advertisement medium) advertisement content selection target quantities during the next time interval=advertisement content total quantity−(accumulated advertisement content selection quantities of first advertisement medium+accumulated advertisement content selection quantities of second advertisement medium)/time intervals converted from advertisement remaining period [Mathematical expression 16]

Also, when the overall advertisement content selection target quantities during the next time interval are calculated, the control unit 430 calculates the advertisement content selection target quantities during the next time interval for the respective advertisement media based on the ratio between the advertisement content selection quantities on the first advertisement medium and the second advertisement medium according to Mathematical expression 17 and Mathematical expression 18.

advertisement content selection target quantities of first advertisement medium during next time interval=daily accumulated advertisement content selection quantities of first advertisement medium/(daily accumulated advertisement content selection quantities of first advertisement medium+daily accumulated advertisement content selection quantities of second advertisement medium)*overall (first advertisement medium+second advertisement medium) advertisement content selection target quantities during next time interval [Mathematical expression 17]

advertisement content selection target quantities of second advertisement medium during next time interval=overall (first advertisement medium+second advertisement medium) advertisement content selection target quantities during next time interval−advertisement content selection target quantities of first advertisement medium during next time interval [Mathematical expression 18]

And, after the advertisement content selection target quantities for the respective advertisement media are calculated for the next time interval, the control unit 430 calculates the advertisement content allocation quantities during the next time interval for the respective advertisement media by additionally applying the compensation coefficient of (1/CTR*100, 1/FR*100) to the advertisement content selection target quantities of the respective advertisement media according to Mathematical expression 19 and Mathematical expression 20.

advertisement content allocation quantities of first advertisement medium during next time interval=advertisement content selection target quantities of first advertisement medium during next time interval*(1/CTR of first advertisement medium*100)*(1/FR of first advertisement medium*100) [Mathematical expression 19]

advertisement content allocation quantities of first advertisement medium during next time interval=advertisement content exposure target quantities of first advertisement medium during next time interval*(1/CTR of second advertisement medium*100)*(1/FR of second advertisement medium*100) [Mathematical expression 20]

Here, the compensation coefficient of 1/CTR*100 is applied for compensating for the difference between the advertisement content selection target quantities calculated for the respective advertisement media and the advertisement content selection quantities substantially acknowledged for the advertisement media.

That is, if the advertisement content allocation quantities for each of the respective advertisement media during the next time interval are set to be equal to the precalculated advertisement content selection target quantities, even when it is supposed that the advertisement content exposed for the number of times corresponding to the advertisement content allocation quantities, it can happen that the advertisement content selection quantities substantially acknowledged for the respective advertisement media do not reach the advertisement content exposure target quantities by a big difference.

For example, when the advertisement content allocation quantity for a specific advertisement medium is set to 10 to be the same as the advertisement content selection target quantity, the FR of the specific advertisement medium is acknowledged to be 80%, and the CRT is acknowledged to be 50%, this means that only 8 pieces of advertisement content are exposed on the specific advertisement medium as a result of the provision of 10 pieces of advertisement content to the specific advertisement medium and only 4 pieces of the exposed advertisement content are selected.

In this case, the probability of the rest six pieces of advertisement content being selected on the specific advertisement medium can be increased by setting the advertisement content allocation quantities to be greater than the advertisement content exposure target quantities.

Therefore, when the CTR, that is, the compensation coefficient (1/CRT*100) reflecting the CTR primarily acknowledged by the specific advertisement medium, is smaller than 100% (50%), the advertisement content quantities for compensating for the small CTR (50%) can be calculated and added to the calculated advertisement content selection target quantities.

Also, when the FR, that is the compensation coefficient (1/FR*100) reflecting the FR acknowledged by the specific advertisement medium, is smaller than 100% (80%), the advertisement content quantities for compensating for the small FR (20%) can be calculated and additionally reflected on the calculated advertisement content selection target quantities, such that the number of pieces of the advertisement content corresponding to the advertisement content exposure target quantities are finally selected on the corresponding advertisement medium.

As described above, according to the advertisement providing system according to another embodiment of the present invention, advertisement content allocation ratios among advertisement media are adjusted to be set based on the advertisement content exhaustion quantities acknowledged for the respective advertisement media, thereby maximally guaranteeing advertisement content provision guarantee ratios (Fill Rates) and selection ratios (Click Through Ratios) required by the respective advertisement media and easily exhausting the advertisement content exhaustion quantities agreed on by the advertisers.

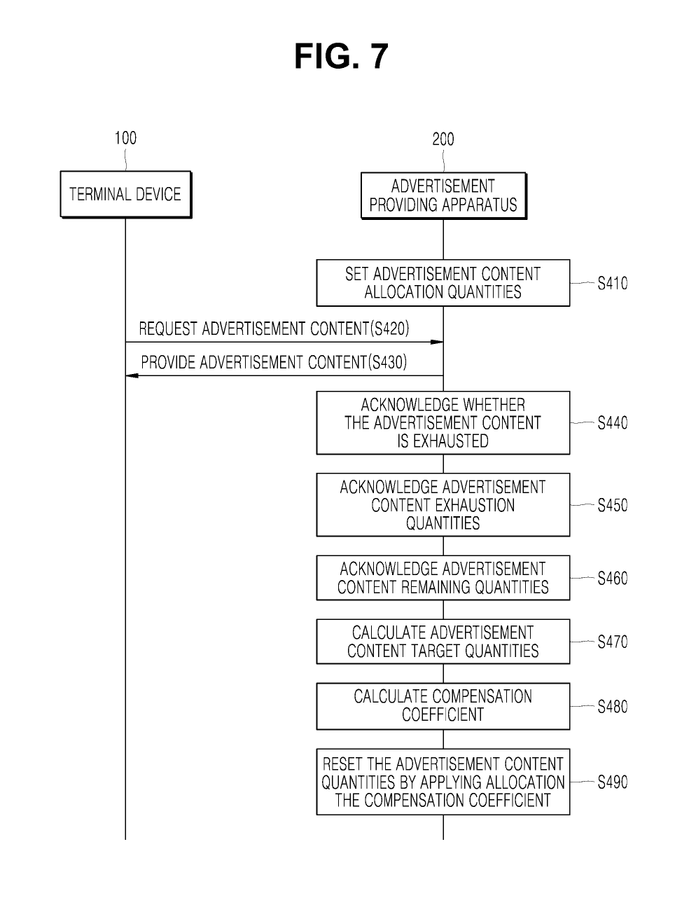

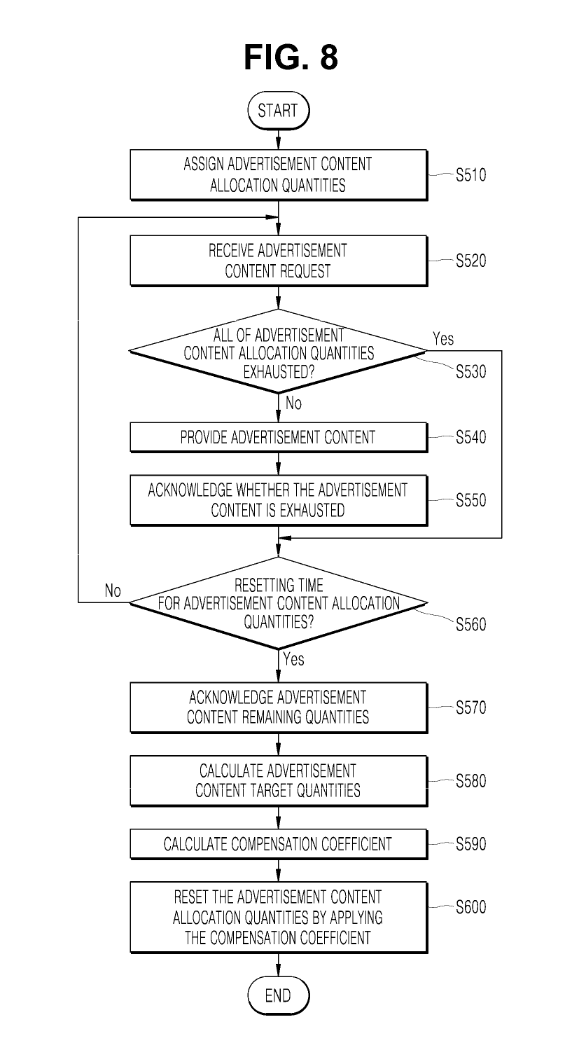

In the following, an advertisement service method according to another embodiment of the present invention is described by referring to FIG. 7 and FIG. 8. Here, the configurations described in the FIG. 5 and FIG. 6 are referred to by using corresponding reference numbers for the convenience of description.

First, operation flows in the advertisement providing system according to another embodiment of the present invention is described by referring to FIG. 7.

For starters, when the advertisement content allocation quantities are set for the first time after the advertisement content is registered from an advertiser, the advertisement providing apparatus 400 sets the advertisement content allocation quantities for each of the first advertisement medium and the second advertisement medium according to the advertisement content allocation ratios preset among the advertisement media (S410).

Then, the terminal device 300 requests to receive the advertisement content from the advertisement providing apparatus 400 through software development kits (SDK) installed on the respective advertisement media according to an execution of the first advertisement medium or the second advertisement medium, and displays the received advertisement content on an advertisement display area of the corresponding advertisement content (S420-S430).

Next, the advertisement providing apparatus 400 acknowledges the advertisement content exhaustion quantities exhausted from the advertisement content allocation quantities for each of the first advertisement medium and the second advertisement medium by receiving the event information from the terminal devices 300 for every set time intervals and acknowledging whether the advertisement content provided to each of the first advertisement medium and the second advertisement medium is normally exhausted (S440-S450).

While doing so, when the advertisement content allocation quantities for each of the first advertisement medium and the second advertisement medium are acknowledged to be exhausted for every time intervals (e.g.: one minute durations), the advertisement providing apparatus 400 accumulates and updates the advertisement content exhaustion quantities exhausted by the first advertisement medium and the second advertisement medium.

Furthermore, when a resetting time point arrives after the initial setting of the advertisement content allocation quantities, the advertisement providing apparatus 400 acknowledges the advertisement content remaining quantities which correspond to the accumulated advertisement content exhaustion quantities acknowledged on the first advertisement medium and the second advertisement medium subtracted from the advertisement content total quantity agreed on to be exhausted by the advertiser (S460). After doing so, the advertisement providing apparatus 400 calculates the overall advertisement content exhaustion target quantities during the next time interval to be exhausted during the next time period by dividing the acknowledged advertisement content remaining quantities by the result value of the conversion from the advertisement remaining period to the time intervals and calculates the advertisement content exhaustion target quantities during the next time interval for the respective advertisement media based on the ratio between the advertisement content exhaustion quantities on the first advertisement medium and the second advertisement medium. Also, the advertisement providing apparatus 400 calculates a compensation coefficient for compensating for the advertisement content allocation quantities for the respective advertisement media based on the ratio of the advertisement content provision quantities with respect to substantial advertisement content exhaustion quantities acknowledged for each of the first advertisement medium and the second advertisement medium (S480).

Then, the advertisement providing apparatus 400 calculates the advertisement content allocation quantities by additionally applying the calculated compensation coefficient to the advertisement content exhaustion target quantities calculated for the respective advertisement media, and resets the calculated result as the advertisement content allocation quantities during the next time interval for the respective advertisement media (S490).

In the following, the operation of the advertisement providing apparatus 400 according to another embodiment of the present invention is described in detail by referring to FIG. 8.

*More specifically, when the advertisement content allocation quantities are set for the first time after the advertisement content is registered from an advertiser, the setting unit 440 sets the advertisement content allocation quantities for each of the first advertisement medium and the second advertisement medium based on the advertisement content allocation ratios preset among the advertisement media under the control of the control unit 430 (S510).

While doing so, when the advertisement content allocation quantities are assigned for the first time, the setting unit 440 divides the advertisement content total quantity registered by an advertiser into the same advertisement content allocation quantities for each of the first advertisement medium and the second advertisement medium and sets the advertisement content allocation quantities.

After doing so, when the advertisement content request for the first advertisement medium or the second advertisement medium is received from a plurality of terminal devices 300 after the advertisement content allocation quantities for each of the first advertisement medium and the second advertisement medium are set, the providing unit 410 extracts the advertisement content corresponding to the advertisement content allocation quantity of the corresponding advertisement medium and provides it to the terminal devices 300 (S520-S540).

In the meantime, the providing unit 410 extracts the advertisement content and provides the extracted advertisement content to a plurality of terminal devices 300 only when remaining quantities which can be provided exist in the set advertisement content allocation quantities.

Next, the acknowledging unit 420 acknowledges the exhaust state of the advertisement content allocation quantities for each of the first advertisement medium and the second advertisement medium by acknowledging whether the advertisement content provided for each of the first advertisement medium and the second advertisement medium for every assigned time intervals (e.g.: one minute durations) is normally exhausted (S550). In the meantime, the acknowledging unit 420 acknowledges the advertisement content exposure quantities corresponding to the quantities of the advertisement content displayed (exposed) on the respective advertisement media, when the type of the advertisement content is CPM, or the advertisement content selection quantities corresponding to the quantities of the advertisement content selected on the respective advertisement media, if the advertisement content type is CPC, as the advertisement content exhaustion quantities exhausted from the advertisement content allocation quantities.

After doing so, when a resetting time point arrives after the initial setting of the advertisement content allocation quantities, the control unit 430 acknowledges the advertisement content remaining quantities which correspond to the accumulated advertisement content exhaustion quantities acknowledged on the first advertisement medium and the second advertisement medium subtracted from the advertisement content total quantity agreed on to be exhausted by the advertiser (S560-S570).

While doing so, if the type of the advertisement content is CPM, the control unit 430 subtracts the accumulated advertisement content exposure quantities acknowledged for the first advertisement medium and the second advertisement medium to acknowledge the advertisement content remaining quantities.

On the contrary, if the type of the advertisement content is CPC, the control unit 430 acknowledges the advertisement content remaining quantities which correspond to the accumulated advertisement content selection quantities acknowledged on the first advertisement medium and the second advertisement medium subtracted from the advertisement content total quantity agreed on to be exhausted by the advertiser. Then, control unit 430 calculates overall advertisement content exposure exhaustion quantities during the next time intervals (for example: one minute) by dividing the advertisement content remaining quantities acknowledged on the first advertisement medium and the second advertisement medium by the result value of the conversion from the advertisement remaining period to the time intervals, and calculates the advertisement content exhaustion target quantities during the next time interval for the respective advertisement media (S580).

While doing so, if the advertisement content type is CPM, the control unit 430 calculates the advertisement content exposure target quantities during the next time interval for the respective advertisement media based on the ratio between the advertisement content exposure quantities on the first advertisement medium and the second advertisement medium.

On the contrary, if the advertisement content type is CPC, the control unit 430 calculates the advertisement content selection target quantities during the next time interval for the respective advertisement media based on the ratio between the advertisement content selection quantities on the first advertisement medium and the second advertisement medium.

Next, when the advertisement content exhausted target quantities during the next time interval for the respective advertisement media are calculated, the control unit 430 calculates a compensation coefficient for compensating for the advertisement content allocation quantities for the respective advertisement media based on the ratio of the advertisement content provision quantities with respect to substantial advertisement content exhaustion quantities acknowledged for each of the first advertisement medium and the second advertisement medium (S590).

While doing so, in the advertisement content type is CPM, the control unit 430 calculates the compensation coefficient (1/FR*100) by reflecting the provision guarantee ratios (FR, Fill Late) for the respective advertisement media corresponding to the ratio between the advertisement content provision quantities and the advertisement content exposure quantities.

On the contrary, when the advertisement content type is CPC, the control unit 430 calculates, in addition to the compensation coefficient based on the aforementioned provision guarantee ratios, the compensation coefficient (1/CTR*100) reflecting the selection ratios (CTR, Click Through Ratio) for the respective advertisement media corresponding to the ratio between the advertisement content exposure quantities and the advertisement content selection quantities.

After doing so, the control unit 430 calculates the advertisement content allocation quantities by additionally applying the calculated compensation coefficient to the advertisement content exhaustion target quantities calculated for the respective advertisement media, and resets the result calculated in the setting unit 440 as the advertisement content allocation quantities during the next time interval for the respective advertisement media (S60!0).

While doing so, if the advertisement content type is CPM, the control unit 430 compensates for the difference between the advertisement content exposure target quantities calculated for the respective advertisement media and the advertisement content exposure quantities substantially acknowledged for the advertisement media by applying the FR to the advertisement content exhaustion target quantities calculated for the respective advertisement media in calculating the advertisement content allocation quantities for the respective advertisement media.

On the contrary, when the advertisement content type is CPC, the control unit 430 calculates the advertisement content allocation quantities for the respective advertisement media by applying the compensation coefficient reflecting the CTR along with the compensation coefficient reflecting the FR to the advertisement content exhausted target quantities calculated for the respective advertisement media.

It is done in order to compensate for the difference between the advertisement content selection target quantities calculated for the respective advertisement media and the advertisement content selection quantities substantially acknowledged for the advertisement media by using the compensation coefficient reflecting the CTR, while compensating for the difference between the advertisement content provision quantities provided to the respective advertisement media and the advertisement content exposure quantities substantially acknowledged for the advertisement media.

As described above, according to the advertisement providing method according to another embodiment of the present invention, advertisement content allocation ratios among advertisement media are adjusted to be set based on the advertisement content exhaustion quantities acknowledged for the respective advertisement media, thereby maximally guaranteeing advertisement content provision guarantee ratios (Fill Rates) and selection ratios (Click Through Ratios) required by the respective advertisement media and easily exhausting the advertisement content exhaustion quantities agreed on by the advertisers.

As described above, by using an advertisement providing method according to another embodiment of the present invention, the advertisement content allocation ratios among advertisement media are set based on the advertisement content exhaustion quantities acknowledged for the respective advertisement media to adjust the advertisement content allocation quantities, thereby maximally guaranteeing advertisement provision guarantee ratio (Fill Rate) required by the respective advertisement media and guaranteeing the quantities agreed on by advertisers related to the provision of the advertisement content.

Meanwhile, the steps of the method or algorithm described in relation to the proposed embodiments can be directly implemented as hardware, or can be embodied as program instructions executable by various computer means and recorded on a computer-readable medium. The computer-readable medium can include program instructions, data files, data structures, etc. exclusively or in combination. The program instructions recorded on the medium can be specifically designed and configured for the present invention or well known to be available by a skilled artisan in computer software. In the example of the computer-readable recording medium, magnetic media such as hard disks, floppy disks, and magnetic tapes, optical media such as digital versatile disks (DVDs), magneto-optical media such as floptical disks, and hardware devices specially configured to store and execute program instructions such as ROMs, RAMs, and flash memories, etc. are included. In the example of the computer instructions, machine language codes created by a compiler as well as a high level language code executable by a computer using an interpreter, etc. are included. The hardware device can be configured to operate as one or more software module for performing the operations of the present invention, and vice versa.

Although the present invention is explained in detail by referring to preferred embodiments, the present invention is not restricted to the above embodiments, and the technical scope of the present invention encompass the range where a person with an ordinary skill in the relevant art can readily vary or modify without deviating from the subject matter as claimed in claims.

### INDUSTRIAL APPLICABILITY

According to the advertisement providing system, the method therefor, and the apparatus applied to the same according to the present invention, limits of the prior art are overcome in that the advertisement content allocation ratios among advertisement media are set based on advertisement content exhaustion quantities acknowledged for the advertisement media and the advertisement content allocation quantities for the advertisement media are adjusted accordingly, which not only enables the applied apparatus to be used for related arts but also empowers the applied apparatus with high marketability, and definitely substantiates the industrial applicability of the present invention.

1. An advertisement providing apparatus characterized in comprising:
a providing unit which, for each of two or more advertisement media, provides advertisement content corresponding to assigned advertisement content allocation quantities;
an acknowledging unit which acknowledges whether the advertisement content is received and the advertisement content allocation quantities are exhausted on each of the two or more advertisement media; and
a control unit which, for each of the two or more advertisement media, assigns the advertisement content allocation quantities for each of the two or more advertisement media based on the advertisement content exhaustion quantities acknowledged in two or more correlated time intervals.

2. The advertisement providing apparatus according to claim 1, wherein the advertisement providing apparatus further comprises:
an assigning unit which assigns the advertisement content allocation quantities for each of the two or more advertisement media based on advertisement content allocation ratios set among the two or more advertisement media,
and the control unit sets the advertisement content allocation ratios based on the advertisement content exhaustion quantities acknowledged for each of the two or more advertisement media, such that the assigning unit assigns the advertisement content allocation quantities.

3. The advertisement providing apparatus according to claim 2, wherein the advertisement content allocation ratios are set based on magnitudes of advertisement content exhaustion scores calculated for each of the two or more advertisement media,
and the control unit adds, for each of the two or more advertisement media, the exhaustion quantities of the advertisement content acknowledged in the two or more time intervals to calculate the advertisement content exhaustion scores for each of the two or more advertisement media.

4. The advertisement providing apparatus according to claim 3,
wherein different weights according to a time sequence of the two or more time intervals are given to each of the advertisement content exhaustion quantities acknowledged in the two or more time intervals,
and the control unit gives a higher weight for an advertisement content exhaustion quantity, which is acknowledged most recently among the advertisement content exhaustion quantities acknowledged in the two or more time intervals, than for the advertisement content exhaustion quantities acknowledged in the rest time intervals to calculate the advertisement content exhaustion scores.

5. The advertisement providing apparatus according to claim 3,
wherein the control unit controls the assigning unit to assign a greater advertisement content allocation quantity for the advertisement media with the biggest magnitude of the advertisement content exhaustion scores among the two or more advertisement media, than for the rest advertisement media.

6. The advertisement providing apparatus according to claim 1,
wherein the advertisement providing apparatus further comprises:
an updating unit which, when the acknowledging unit acknowledges that advertisement content allocation quantities are exhausted on each of the two or more advertisement media, accumulates to update the advertisement content exhaustion quantities exhausted on the two or more advertisement media,
and the control unit assigns advertisement content remaining quantities, which correspond to advertisement content exhaustion quantities subtracted from an advertisement content total quantity, as the advertisement content allocation quantities for the two or more advertisement media.

7. (canceled)

8. An operation method for an advertisement providing apparatus characterized in comprising:
a providing step for providing, for each of two or more advertisement media, advertisement content corresponding to assigned advertisement content allocation quantities;
an acknowledging step for acknowledging whether the advertisement content is received and the advertisement content allocation quantities are exhausted on each of the two or more advertisement media; and
a controlling step for, for each of the two or more advertisement media, assigning the advertisement content allocation quantities for each of the two or more advertisement media based on the advertisement content exhaustion quantities acknowledged in two or more correlated time intervals.

9. The advertisement providing method according to claim 8,
wherein the method further comprises: an assigning step for assigning the advertisement content allocation quantities for each of the two or more advertisement media based on advertisement content allocation ratios set among the two or more advertisement media,
and in the controlling step the advertisement content allocation ratios are set based on the advertisement content exhaustion quantities acknowledged for each of the two or more advertisement media, such that the advertisement content allocation quantities are assigned in the assigning step.

10. The advertisement providing method according to claim 9,
wherein the advertisement content allocation ratios are set based on magnitudes of advertisement content exhaustion scores calculated for each of the two or more advertisement media,
and in the controlling step, for each of the two or more advertisement media, the exhaustion quantities of the advertisement content acknowledged in the two or more time intervals are added to calculate the advertisement content exhaustion scores for each of the two or more advertisement media.

11. The advertisement providing method according to claim 10,
wherein different weights according to a time sequence of the two or more time intervals are given to each of the advertisement content exhaustion quantities acknowledged in the two or more time intervals,
and in the controlling step, a higher weight is given to an advertisement content exhaustion quantity, which is acknowledged most recently among the advertisement content exhaustion quantities acknowledged in the two or more time intervals, than to the advertisement content exhaustion quantities acknowledged in the rest time intervals to calculate the advertisement content exhaustion scores.

12. The advertisement providing method according to claim 9,
wherein in the controlling step, a greater advertisement content allocation quantity is assigned for the advertisement media with the biggest magnitude of the advertisement content exhaustion scores, among the two or more advertisement media, than for the rest advertisement media in the assigning step.

13. The advertisement providing method according to claim 8,
wherein the method further comprises: an updating step in which, when in the acknowledging step it is acknowledged that the advertisement content allocation quantities are exhausted on each of the two or more advertisement media, the advertisement content exhaustion quantities exhausted on the two or more advertisement media are accumulated and updated,
and in the controlling step, advertisement content remaining quantities, which correspond to advertisement content exhaustion quantities subtracted from an advertisement content total quantity, are assigned as the advertisement content allocation quantities for the two or more advertisement media.

14. (canceled)

15. An advertisement providing apparatus characterized in comprising:
a providing unit which, for each of two or more advertisement media, provides advertisement content corresponding to set advertisement content allocation quantities;
an acknowledging unit which acknowledges whether the advertisement content is received and the advertisement content allocation quantities are exhausted on each of the two or more advertisement media; and
a control unit which sets the advertisement content allocation quantities for each of the two or more advertisement media based on the advertisement content exhaustion quantities acknowledged for each of the two or more advertisement media.

16. The advertisement providing apparatus according to claim 15,
wherein the advertisement providing apparatus further comprises:
a setting unit which sets the advertisement content allocation quantities for each of the two or more advertisement media,
and the setting unit sets the advertisement content allocation quantities for each of the two or more advertisement media based on advertisement content allocation ratios sets among the two or more advertisement media.

17. The advertisement providing apparatus according to claim 16,
wherein the control unit sets the advertisement content allocation ratios based on the advertisement content exhaustion quantities acknowledged for each of the two or more advertisement media such that setting unit sets the advertisement content allocation quantities.

18. The advertisement providing apparatus according to claim 15,
wherein the advertisement providing apparatus further comprises:
an updating unit which, when the acknowledging unit acknowledges that the advertisement content allocation quantities are exhausted on each of the two or more advertisement media, accumulates to update the advertisement content exhaustion quantities exhausted on the two or more advertisement media,
and the control unit divides advertisement content remaining quantities, which correspond to the accumulated advertisement content exhaustion quantities subtracted from an advertisement content total quantity agreed on by an advertiser, to set the advertisement content allocation quantities for the two or more advertisement media.

19. The advertisement providing apparatus according to claim 18,
wherein compensation coefficients calculated for each of the two or more advertisement media are applied to the advertisement content allocation quantities set for each of the two or more advertisement media,
and the control unit applies the compensation coefficients to each of the advertisement content remaining quantities divided for the two or more advertisement media to set the advertisement content allocation quantities for each of the two or more advertisement media.

20. The advertisement providing apparatus according to claim 19,
wherein the compensation coefficients calculated for each of the two or more advertisement media are calculated based on ratios of the advertisement content exhaustion quantities acknowledged for each of the two or more advertisement media with respect to advertisement content provision quantities provided for each of the two or more advertisement media.

21-28. (canceled)
